(19) United States
(12) Patent Application Publication
(10) Pub. No.: US 2026/0304381 A1
(43) Pub. Date: Oct. 1, 2026

(54) PEI BITMAP DETERMINATION UNDER DYNAMIC PAGING ADAPTATION

(71) Applicant: QUALCOMM Incorporated, San Diego, CA (US)

(72) Inventors: Ahmed Attia ABOTABL, San Diego, CA (US); Hung Dinh LY, San Diego, CA (US); Qing LI, Princeton Junction, NJ (US)

(21) Appl. No.: 19/530,231

(22) Filed: Feb. 4, 2026

Related U.S. Application Data
(60) Provisional application No. 63/779,084, filed on Mar. 27, 2025.

(51) Int. Cl. H04W 68/02; H04W 52/02

(52) U.S. Cl. CPC H04W 68/02; H04W 52/0212

(57) ABSTRACT

A UE receives a paging early indication (PEI) segment for multiple non-adapted paging occasions prior to one or more PEI segments for one or more additional paging occasions that are scheduled to occur between the multiple non-adapted paging occasions. The UE wakes up to monitor at least one of the multiple non-adapted paging occasions or the one or more additional paging occasions based on a PEI indication.

### CROSS REFERENCE TO RELATED APPLICATION

This application claims the benefit of and priority to U.S. Provisional Application Ser. No. 63/779,084, entitled “PEI BITMAP DETERMINATION UNDER DYNAMIC PAGING ADAPTATION” and filed on Mar. 27, 2025, which is expressly incorporated by reference herein in its entirety.

### TECHNICAL FIELD

The present disclosure relates generally to communication systems, and more particularly, to wireless communication that includes paging.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 6G, which is an enhancement of 5G New Radio (NR) and is a part of a continuous mobile broadband evolution promulgated by Third Generation Partnership Project (3GPP) to meet new requirements associated with latency, reliability, security, scalability (e.g., with Internet of Things (IoT)), capacity, location services, energy efficiency, artificial intelligence (AI) integration, and other requirements. Some aspects of 6G may be based on 5G NR and 4G Long Term Evolution (LTE). There exists a need for further improvements in 6G/5G technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a user equipment (UE). The apparatus is configured to receive a paging early indication (PEI) segment for multiple non-adapted paging occasions prior to one or more PEI segments for one or more extended paging occasions that are scheduled to occur between the multiple non-adapted paging occasions; and wake up to monitor at least one of the multiple non-adapted paging occasions or the one or more extended paging occasions based on a PEI indication.

In an aspect of the disclosure, a method, a computer-readable medium, and an apparatus are provided for wireless communication at a network node. The apparatus is configured to transmit a paging early indication (PEI) segment for multiple non-adapted paging occasions prior to one or more PEI segments for one or more extended paging occasions that are scheduled to occur between the multiple non-adapted paging occasions; and page at least one user equipment (UE) in at least one of the multiple non-adapted paging occasions or the one or more extended paging occasions based on a PEI indication.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network, in accordance with various aspects of the present disclosure.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network, in accordance with various aspects of the present disclosure.

FIG. 4A illustrates example aspects of paging, including a PEI, in accordance with various aspects of the present disclosure.

FIG. 4B illustrates example aspects of a paging cycle, in accordance with various aspects of the present disclosure.

FIG. 5 illustrates example aspects of a PEI bitmap mapping, in accordance with various aspects of the present disclosure.

FIG. 6 illustrates example aspects of a PEI bitmap mapping, in accordance with various aspects of the present disclosure.

FIG. 7A and FIG. 7B illustrate example aspects of PEI bitmap mapping, in accordance with various aspects of the present disclosure.

FIG. 8A and FIG. 8B illustrate example aspects of PEI bitmap mapping, in accordance with various aspects of the present disclosure.

FIG. 9A and FIG. 9B illustrate example aspects of PEI bitmap mapping, in accordance with various aspects of the present disclosure.

FIG. 10 is a flowchart of a method of wireless communication, in accordance with various aspects of the present disclosure.

FIG. 11A and FIG. 11B are flowcharts of methods of wireless communication, in accordance with various aspects of the present disclosure.

FIG. 12A and FIG. 12B are flowcharts of methods of wireless communication, in accordance with various aspects of the present disclosure.

FIG. 13 is a diagram illustrating an example of a hardware implementation for an example apparatus and/or network entity, in accordance with various aspects of the present disclosure.

FIG. 14 is a diagram illustrating an example of a hardware implementation for an example network entity, in accordance with various aspects of the present disclosure.

### DETAILED DESCRIPTION

A UE in a communication system may enter an idle state or an inactive state (e.g., RRC inactive or RRC idle state), e.g., to preserve battery power if the UE does not have an ongoing data to exchange (e.g., transmit or receive) with a network. As an example, in an RRC idle state, the UE may monitor for a paging message at a set of times (e.g., paging occasions). The use of a paging early indication (PEI) may enable added power savings by indicating to a UE (or a UE subgroup) indicate whether to monitor a particular paging occasion (PO). The bits of the PEI bitmap map to the subgroups and further map to the POs in order (e.g., in a time order). Further flexibility and/or energy savings may be achieved through paging adaptation, e.g., in which a network may provide additional POs (which may also be referred to as extended POs, additional POs based on paging adaptation, etc.). However, some UEs may not support a paging adaptation capability and may not be aware of the additional POs. Aspects presented herein enable co-existence by UEs having different capabilities (e.g., including UEs that support paging adaptation and UEs that do not support paging adaptation). For example, the network node may transmit multiple configurations of parameters for paging adaptation, including a first configuration for PEI segment for the multiple non-adapted paging occasions and a second configuration for the one or more PEI segments for the one or more additional paging occasions. For example a UE may receive configurations for any of a PEI frame offset, a payload size for a DCI format 2_7, and/or a number of POs per PEI separately for non-adapted POs and the additional POs. Some aspects presented herein provide for PEI mapping to POs in a way that enables co-existence by UEs having the different capabilities. For example, the network node may map the non-adapted POs to the first segments of the PEI to enable the UEs that are not aware of the additional POs to correctly interpret the PEI.

Particular aspects of the subject matter described in this disclosure can be implemented to realize one or more of the following potential advantages. The aspects enable paging adaptation while also providing for co-existence with UEs that do not support a paging adaptation capability by enabling both UEs to correctly interpret a PEI bitmap. The aspects presented herein may enable the use of interlaced PO, e.g., including combinations of non-adapted POs that are interlaced with additional POs.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 6G NR systems, may be arranged in multiple manners with various components or constituent parts. In a communication system, such as a 6G or 5G NR system or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, 6G node, 6G RAN, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

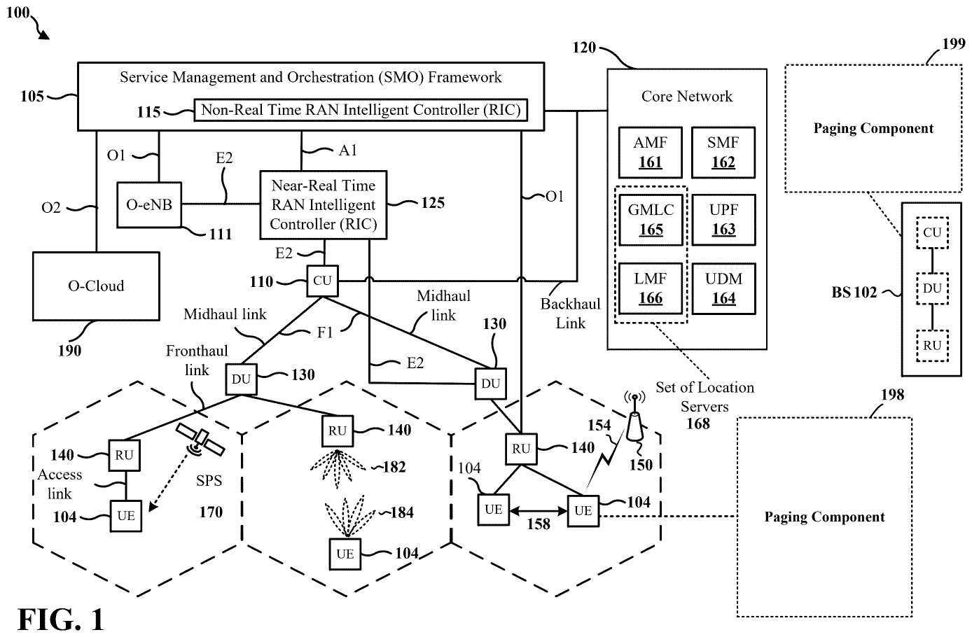

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. Two initial operating bands have been identified as frequency range designations FR1 (410 MHz-7.125 GHZ) and FR2 (24.25 GHz-52.6 GHz). Although a portion of FR1 is greater than 6 GHz, FRI is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend operation beyond 52.6 GHz. For example, three higher operating bands have been identified as frequency range designations FR2-2 (52.6 GHz-71 GHz), FR4 (71 GHz-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a component 198 that may be configured to receive a PEI segment for multiple non-adapted paging occasions prior to one or more PEI segments for one or more extended paging occasions that are scheduled to occur between the multiple non-adapted paging occasions; and wake up to monitor at least one of the multiple non-adapted paging occasions or the one or more extended paging occasions based on a PEI indication. In certain aspects, the base station 102 may have a component 199 that may be configured to transmit a paging early indication (PEI) segment for multiple non-adapted paging occasions prior to one or more PEI segments for one or more extended paging occasions that are scheduled to occur between the multiple non-adapted paging occasions; and page at least one user equipment (UE) in at least one of the multiple non-adapted paging occasions or the one or more extended paging occasions based on a PEI indication.

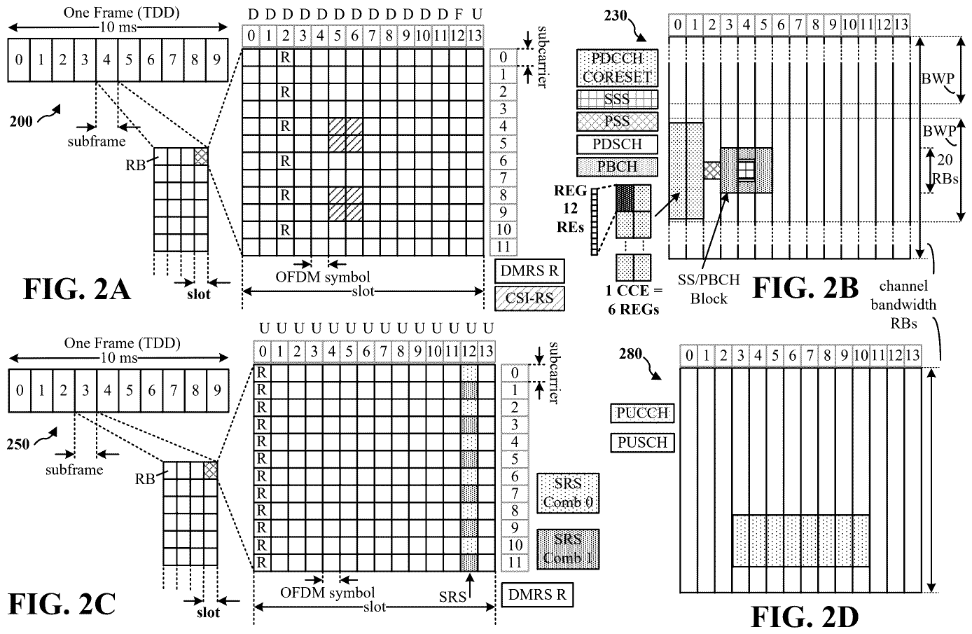

FIG. 2A is a diagram 200 illustrating an example of a first subframe within an example frame structure. FIG. 2B is a diagram 230 illustrating an example of DL channels within an example subframe. FIG. 2C is a diagram 250 illustrating an example of a second subframe within a frame structure. FIG. 2D is a diagram 280 illustrating an example of UL channels within a subframe. The frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δƒ = 2μ · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

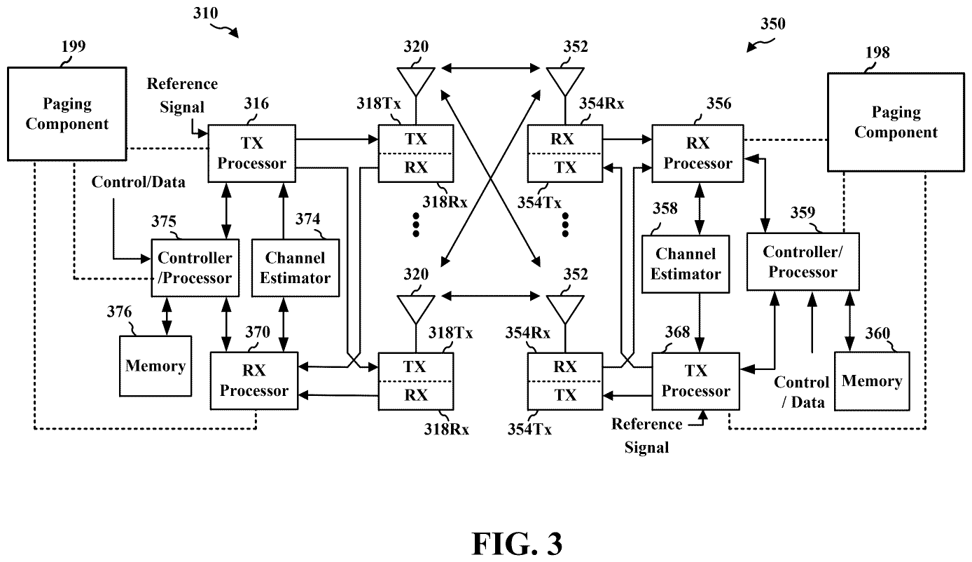

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality. The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the paging component 198 of FIG. 1.

At least one of the TX processor 316, the RX processor 370, and the controller/processor 375 may be configured to perform aspects in connection with the paging component 199 of FIG. 1.

A UE in a communication system may enter an idle state or an inactive state (e.g., RRC inactive or RRC idle state), e.g., to preserve battery power if the UE does not have ongoing data to exchange (e.g., transmit or receive) with a network. As an example, in an RRC idle state, the UE may monitor for a paging message at a set of times (e.g., paging occasions). The UE is able to preserve power by skipping monitoring between paging occasions. For example, the UE may turn off a receiver or reduce receiver operation, when the UE is not monitoring for a paging message (e.g., between paging occasions). In some aspects, a UE may monitor for PDCCH transmissions based on a discontinuous reception (DRX) configuration that includes periodic ON durations in which the UE monitors for the PDCCH transmissions and OFF durations when the UE may skip monitoring for the PDCCH transmissions. The UE may use other similar techniques to preserve battery power at the UE. When a network receives new data for the UE or when the network determines to transmit new data to the UE for any of a variety of reasons, the network may transmit a paging message to probe the idle UE so that the UE may prepare to receive the new data. Among various examples, the network may send the page to trigger an RRC set up (e.g., to establish, re-establish, or resume an RRC connection) with the UE and/or to provide a system information modification, a public warning system notification, PDSCH, or other downlink signaling to the UE.

In some aspects, a reference signal, such as TRS or CSI-RS, may be transmitted for idle or inactive mode UEs. As an example, a TRS may be reference signal to assist the UE in time and frequency tracking with the network. An idle or inactive mode UE may be configured to receive the TRS for performing tracking loop updates, for example.

In some aspects, a network node may use a PEI to indicate whether any UE served by the network node is to monitor a particular paging occasion (PO). For example, the network node may transmit the PEI before a PO to indicate that a UE (or a UE is part of a subgroup) will be paged in an upcoming PO. The PEI may also be used in connection with UE subgrouping, where UEs are grouped into a set of groups. If subgroups of UEs are configured, the PEI may indicate whether a subgroup is to monitor for paging in a PO (e.g., indicating that there will be paging for one of the UEs in a particular subgroup). If a subgroup of UEs is not configured, the PEI may indicate whether individual UEs are to monitor for paging in a PO. The power consumption for receiving the PEI may be lower than for decoding a paging PDCCH, for example. The PEI may also facilitate power saving because paging PDSCH decoding may be reduced, e.g., when the PEI indicates that a UE will not be paged in a PO.

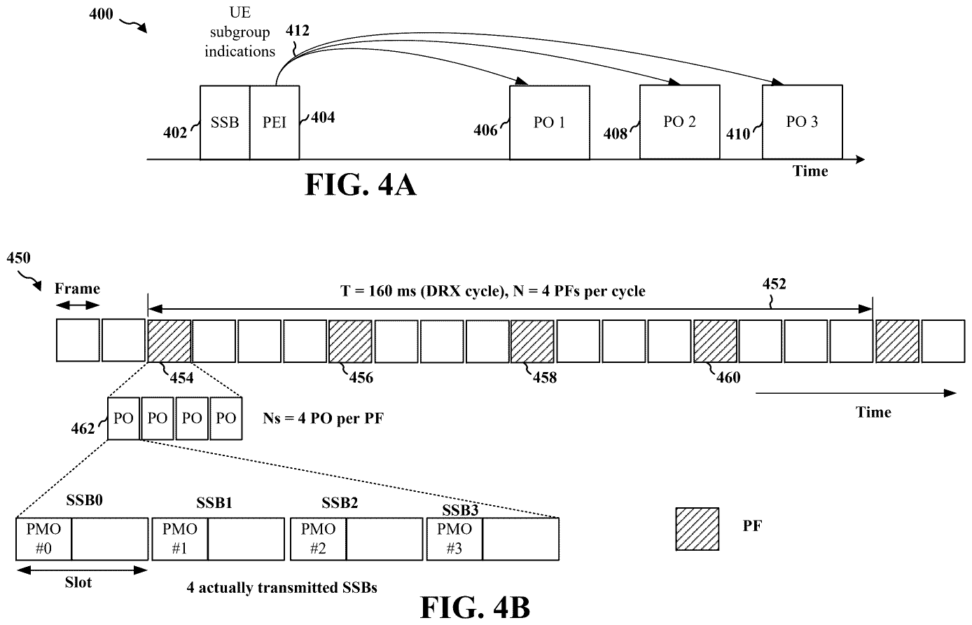

FIG. 4A is an example diagram 400 showing a PEI 404 transmitted following an SSB occasion 402. By transmitting the PEI near the SSB, the UE is able to more efficiently use the time at which the UE wakes up to receive the SSB. As shown by the arrows 412, the PEI includes indications for each of the PO occasions (e.g., 406, 408, and 410) informing UEs or UE groups (which may be referred to as UE subgroups) whether there will be paging to be monitored. The PEI may be a particular format of downlink control information (DCI), such as DCI format 2_7. If a UE (or a UE subgroup) does not receive an indication to monitor any of the POs (e.g., 406, 408, and 410), the UE may skip monitoring for paging during the POs, which enables the UE to save additional power.

FIG. 4B is a diagram 450 showing paging frames and PO resources within a DRX cycle 452. The example DRX cycle in FIG. 4B is 160 ms and includes 4 paging frames (PFs) (e.g., PF 454, PF 456, PF 458, and PF 460). The length of the DRX cycle, the number of PFs per DRX cycle, the number POs per PF, and the number of PDCCH monitoring occasions (PMOs) per PO are merely to illustrate the concept of paging resources in a DRX cycle. The concepts may be similarly applied for any length of DRX cycle, any number of PFs, any number of POs, and/or any number of PMOs. FIG. 4B shows an example in which each PF has 4 POs. FIG. 4B shows that each PO includes resources associated with multiple SSBs, e.g., PO 462 is shown as including resources (e.g., slots) for the transmission of SSB index 0, SSB index 1, SSB index 2, and SSB index 3. A system frame number (SFN) for a PF may be based on

$$( SFN + {PF}_{offset} ) mod T = \frac{T}{N} ( UEID mod N ) ,$$

where PF_{offset} is a paging frame offset, T represents a period of time, UEID is based on an identifier for a UE, and N is the number of PFs per cycle. A PO index may be based on, e.g.,

$${i}_{s} = floor ( \frac{UEID}{N} ) mod {N}_{s} ,$$

where N is the number of PFs per cycle, UEID is based on an identifier for a UE, and Nₛ is the number of POs per PF.

The UE may receive a configuration (e.g., in a SIB such as SIBI or an RRC configuration) that indicates one or more parameters for the UE to use in connection with monitoring for and receiving paging. For example, the configuration may be received in a paging control channel (PCCH) configuration (which may be referred to as a “PCCH-Config” as part of a “DownlinkConfigCommonSIB” that provides common downlink parameters of a cell). The configuration for paging may indicate one or more of a paging cycle, an extended paging cycle, a value for n, paging offset information (e.g., which may be indicated with a parameter such as “nAndPagingFrameOffset”), a number of PMOs corresponding to an SSB within a PO (e.g., which may be indicated as “nrofPDCCH-MonitoringOccasionPerSSB-InPO”), and/or the number of POs per PF (e.g., which may be represented as “ns” or “Nₛ”), among other example parameters. For example, the paging cycle may have a length of 32 radio frames, 64 radio frames, 128 radio frames, or 256 radio frames, among other examples, whereas the extended paging cycle may have a length of 256 radio frames, 512 radio frames, or 1024 radio frames, among other examples, the paging cycle is a fundamental parameter that specifies how often a UE is to wake up to check for paging messages. The cycle can be indicated in terms of radio frame intervals, allowing for flexible configurations such as 32, 64, 128, or 256 frames. Longer intervals reduce energy consumption by reducing the frequency of paging monitoring, yet may introduce added latency. The parameter “nAndPagingFrameOffset,” for example, may be used by the UE to derive a number of total paging frames in a period of time T (which may be based on a default paging cycle) and a paging frame offset (e.g., PF offset). The PF offset indicates a timing within a paging cycle where the paging occurs. The offsets can be subdivided into smaller intervals, such as half, quarter, eight or sixteenth for added flexibility in paging occasion placement. A value of oneSixteenthT corresponds to T/16, a value of oneEighthT corresponds to T/8, and so on.

The PEI may be configured with parameters that match, align with, or are based on or otherwise associated with the paging configuration for the UE. For example, the configuration (which may be referred to as a PEI-Config) may indicate one or more of a payload size for the PEI (e.g., payloadSizeDCI-2-7), an offset for the PEI (e.g., pei-FrameOffset that indicates an offset in number of frames from the start of a reference frame for the PEI to start), and/or the number of POs associated with one PEI monitoring occasion (e.g., po-NumPerPEI). The number of POs per PEI monitoring occasion (e.g., POnumPerPEI) may be based on (or a factor of) the total PO number in a paging cycle (e.g., N×Nₛ). The PEI indicates POnumPerPEI PO(s) in one or two consecutive paging frames (PFs), for example. In some aspects, the value range for POnumPerPEI may be {1, 2, 4, 8}. POnumPerPEI can be smaller than PO number per PF (Nₛ). POnumPerPEI is a multiple of Nₛ when POnumPerPEI is larger than Nₛ.

Each PEI has POnumPerPEI bit segment(s), where each segment has K bits. For example, K=subgroupsNumPerPO if subgrouping is configured, otherwise K=1. The size of the bitmap (e.g., which may be referred to as the paging indication bitmap or PEI bitmap) is POnumPerPEI×subgroupsNumPerPO if subgrouping is configured, otherwise it is POnumPerPEI.

The UE may receive a configuration of parameters for subgrouping, such as a total number of subgroups per PO (e.g., subgroupsNumPerPO) for the UE to read a subgroup indication from physical-layer signalling. The subgroupsNumPerPO field may represent, e.g., the sum of network assigned and UEID-based subgroups supported by the network, and/or a number of of subgroups per PO for UE to read subgroups indication from physical-layer signalling for a UEID-based subgrouping (e.g., subgroupsNumForUEID).

The bits of the PEI bitmap map to the subgroups and POs. A UE determines the mapping to the UE's subgroup or group based on an index of its associated bit segment, where the index is based on a PO index within the paging cycle. The PO index is consecutively counted for POs across all PFs in the paging cycle. The PO index is mapped across all PFs to a bit segment based on the relative PO index within bitmap by i_{PO}=((UE_ID mod N)×Nₛ+iₛ) mod POnumPerPEI, where N indicates the total number of paging frames in paging cycle and iₛ indicates an index of the PO within the paging frame. If subgrouping is configured, within the bit segment, the bit that is used as the paging indication for UE's subgroup is based on the UE's subgroup index i_{SG}, e.g. and can be represented as:

$$Bit {i}_{PO} \times K + {i}_{SG} of the paging indication bitmap$$

For each bit of the PEI, a first bit value (e.g., a value of 1) indicates for the UE (or UE subgroup) to process the paging PDCCH), and a second bit value (e.g., a value of 0) indicates that the UE is not required to process the paging PDCCH. Although the example is given for the values of 1 and 0, the concept of the use of two different bit values can similarly be applied using the opposite bit values.

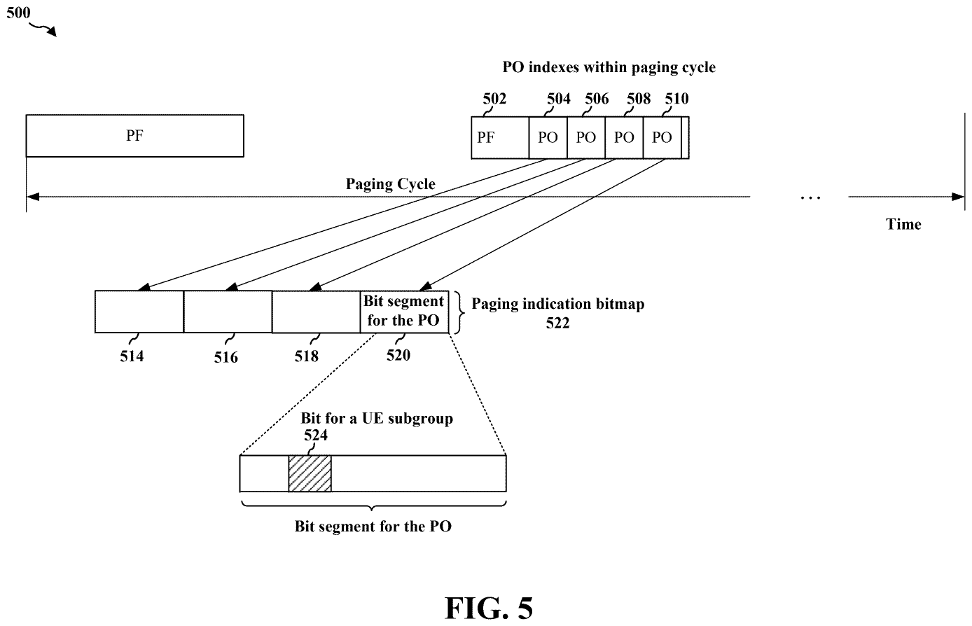

FIG. 5 is a diagram 500 illustrates an example of a mapping between segments (e.g., 514, 516, 518, and 520) of a PEI bitmap 522 and POs (e.g., 504, 506, 508, and 510) within a PF 502. As shown in FIG. 5, the PO 504 maps to the PEI segment 514, the PO 506 maps to the PEI segment 516, the PO 508 maps to the PEI segment 518, and the PO 510 maps to the PEI segment 520. Each bit segment 514, 516, 518, and 520 includes bits for each of the configured UE subgroups for the corresponding PO. FIG. 5 shows an example bit 524 within the bitmap segment 520 that maps to the PO 510. For example, if the bit 524 has a value of “0,” the bit of the PEI indicates that the corresponding UE subgroup can skip monitoring for paging in the PO 510. If the bit 524 has a value of “1,” the bit of the PEI indicates that the network has paging for at least one UE of the UE subgroup to be sent in the PO 510. In response, the UEs of the UE subgroup can monitor the PO 510 for the paging.

In some aspects, adaptions may be incorporated for increased power savings. As an example, for network energy saving (NES), there may be dynamic adaptation for random access, e.g., such as changes or adaptation to physical random access channel (PRACH) resources in a time domain, such as adapting/changing a periodicity of the PRACH resources. The network may adjust, adapt, or change common signals and channel transmissions (e.g., signals and channels transmissions that are common to UEs served by the network node). As an example, the network node may change or adapt the SSB in a time domain, as adapting/changing a periodicity of the SSBs. In some aspects, the network node may adapt PRACH resources in a spatial domain (e.g., based on non-uniform PRACH resources per SSB). In some aspects, such adaptation may include the adaptation of paging occasions. Such adaptation may include confining the paging occasions in the time domain. While such adaptations allow for added flexibility in communication between a network and UEs that support such adaptation, it is helpful for the adaptations to be applied in a way that allows for co-existence with UEs that do not support such a capability for adaptations (e.g., which may be referred to as legacy UEs, in some examples).

For paging adaptations, values of N smaller than T/32 may not be supported, in some aspects. In some aspects, there may be a maximum value for Nₛ (e.g., a maximum number of POs per PF), such as a maximum Nₛ of 8. In order to accommodate such paging adaptations, a network node may transmit a separate PEI configuration. For example, the use of a separate PEI configuration enables UEs that do not support paging adaptation (e.g., which may be referred to as legacy UEs) to be configured with a first PEI configuration, and UEs that do support paging adaptation to be configured with a second PEI configuration. This helps to enable co-existence, because UEs that do not support the paging adaptation can continue to operate without being aware of the second PEI configuration. In some aspects, the paging adaptations may be configured semi-statically and can be updated via system information update notifications. A UE may indicate support for paging adaptation to the network, e.g., such as in capability signaling. As an example, the UE may indicate support for a UE capability that relates to NES paging enhancement, e.g., in UE-RadioPagingInfo transmitted to the network. In some aspects, the UE may indicate support for a common capability for a set of NES features (e.g., all NES features). In other aspects, the UE may indicate support for paging adaptation separately from other NES features. In some aspects, the UE may separately indicate support for various paging adaptation features or parameters.

There can be various options for PEI indication for paging adaptation. For example, the PEI bits mapped to the POs for UEs that do not support paging adaptation (e.g., a which may be referred to interchangeably as a first set of POs, legacy POs, non-adapted POs, and/or non-extended POs) and the PEI bits mapped to the additional POs (e.g., for UEs that support paging adaption) may be multiplexed in the same PEI, e.g., in the same DCI 2_7. In other aspects, the PEI bits mapped to the POs for the UEs that do not support paging adaptation (e.g., legacy POs) may be sent in a separate PEI (e.g., separate DCI 2_7) than the PEI bits for the additional POs may not be multiplexed in the same DCI 2_7, e.g., rather than being multiplexed in the same DCI 2_7.

If the PEI bits are multiplexed in the same DCI 2_7, mapping the POs in order to the PEI bitmap may confuse a UE that does not support paging adaptation (e.g., which may be referred to as a legacy UE) because the UE is not aware of the additional POs provided by the paging adaptation. Aspects presented herein provide for interlaced legacy and additional POs (e.g., adapted POs) by providing PEI bitmap mapping aspects that take into account a UE bitmap determination by UEs that do not support the paging adaptation.

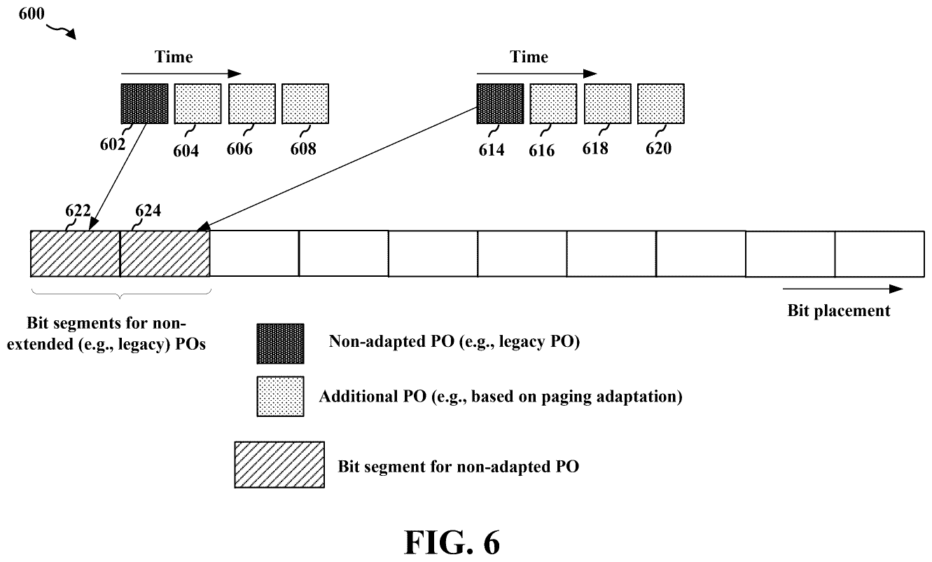

FIG. 6 is a diagram 600 that shows example aspects of PEI bitmap mapping that allows co-existence of different types of UEs when additional POs are interlaced with the non-adapted POs (e.g., for UEs that do not support paging adaptation). For example, FIG. 6 shows that additional POs 604, 606, and 608 are located in time between (e.g., interlaced with) the non-adapted POs 602 and 614. In order to enable the UEs that do not support paging adaption, and therefore are not aware of the additional POs 604, 606, 608, 616, 618, and 620, to properly interpret the PEI bitmap, the bitmap segments for the non-adapted POs may be included at the beginning of the bitmap, prior to the bitmap segments for the additional POs (e.g., additional POs based on paging adaptation). FIG. 6 illustrates the non-adapted PO 602 (e.g., legacy PO) maps to the first bitmap segment 622, and the non-adapted PO 614 maps to second bitmap segment 624, even though POs 604, 606, and 608 occur between the non-adapted POs 602 and 614. Each of the bitmap segments have k bits (e.g., a bit for each of the configured UE subgroups). For example, the bitmap segments may start with the legacy bitmap segments then include the additional bitmap segments for the paging adaptions. As the bitmap segments for the POs 602 and 614 are first, the UEs that are not aware of the additional POs can correctly identify and process the bitmap segments for the POs 602 and 614.

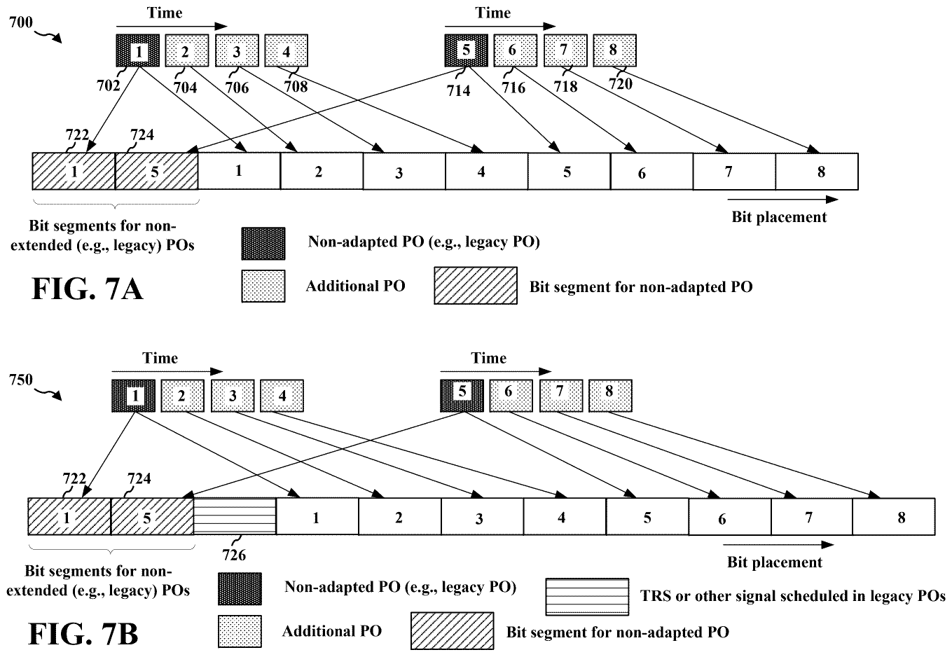

FIG. 7A is a diagram 700 showing an example, similar to FIG. 6 in which the non-adapted POs 702 and 714 map to the bitmap segments 722 and 724 at the start of the PEI bitmap. FIG. 7A further illustrates an example in which the following bitmap segments of the PEI may map to each of the POs in order, e.g., including both the non-adapted POs 702 and 714 and the additional POs 704, 706, 708, 716, 718, and 720.

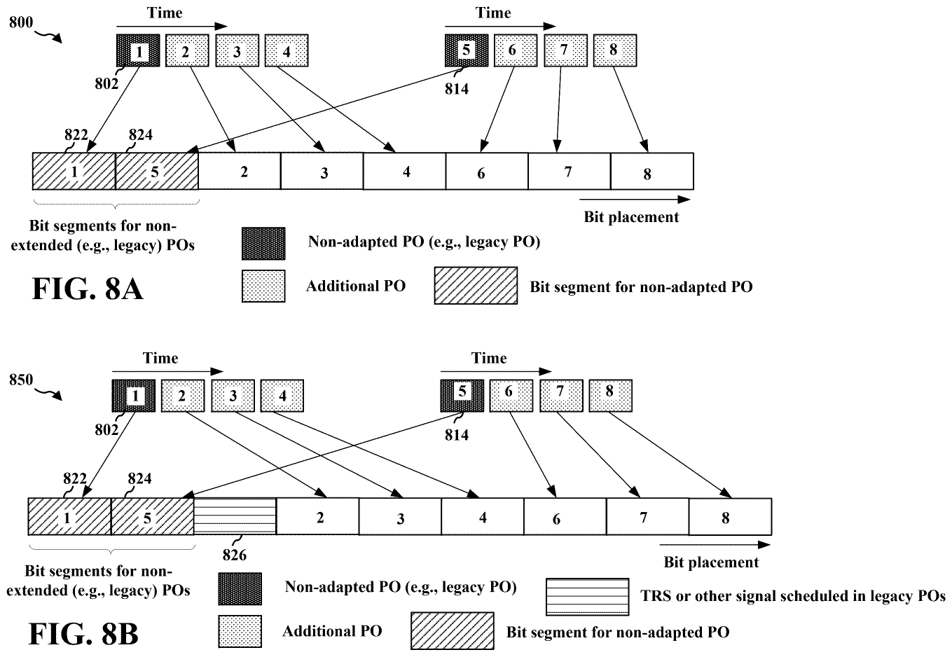

FIG. 8B is a diagram 800 showing an example, similar to FIG. 6 in which the non-adapted POs 802 and 814 map to the bitmap segments 822 and 824 at the start of the PEI bitmap. FIG. 8A further illustrates an example in which the following bitmap segments of the PEI may map to the additional POs 704, 706, 708, 716, 718, and 720 (and not the non-adapted POs) in order. Whereas in FIG. 7A, the POs 702 and 714 are mapped twice to the PEI bitmap segments, in FIG. 8A, the POs 802 and 814 are each mapped to a single bitmap segment.

In some aspects, an additional signal may be provided between the bitmap segments 722 and 724 for the non-adapted POs and the later bitmap segments for the additional POs. For example, FIG. 7B is a diagram 750 showing a bitmap segment mapping similar to FIG. 7A. However, in FIG. 7B, the bitmap segments 722 and 724 are separated by a signal 726 from the bitmap segments that include the additional mapping for the additional POs. The additional signal 726 may be a TRS for example, or another signal that is indicated by, scheduled by, or associated with the PEI segments (e.g., 722 and 724). The inclusion of the additional signal 726 (e.g., TRS) following the bitmap segments 722 and 724 enables co-existence with UEs that do not support the paging adaptation, as they may expect the additional signal 726 because they are not aware of the additional bits of the PEI. FIG. 8B is a diagram 850 showing a bitmap segment mapping similar to FIG. 8A. However, in FIG. 8B, the bitmap segments 822 and 824 are separated by a signal 826 from the bitmap segments that include the additional mapping for the additional POs, e.g., as described in connection with FIG. 7B.

For example, a UE in an RRC_IDLE state or an RRC_INACTIVE state can be provided by a TRS resource set configuration that indicates a set of TRS occasions. If the TRS resource set configuration is provided, if a DCI format 2_7, if a PEI search space is provided, and a DCI format 1_0 with CRC scrambled by P-RNTI includes a TRS availability indication field that provides a bitmap to groups of TRS resource sets where the configuration of each TRS resource set includes an association to a bit of the bitmap.

A value of ‘1’ for a bit of the bitmap (e.g., PEI bitmap) may indicate a presence of an associated TRS resource sets for the multiple of the number of frames, starting from a SFN determined from (SFN+PF_offset)modT=0 that corresponds to the frame within the DRX cycle that includes the PDCCH providing the PEI (e.g., DCI format 2_7), or paging DCI (e.g., the DCI format 1_0 with CRC scrambled by P-RNTI), with the TRS availability indication field indicating the TRS resource sets, where T is provided by the default paging cycle. A value of ‘0’ for a bit of the bitmap (e.g., PEI bitmap) may instead indicate no change to a current assumption for the availability or unavailability of associated TRS resource sets.

A UE can receive first and second PDCCHs that provide DCI format 2_7 (e.g., PEI) or DCI format 1_0 with CRC scrambled by P-RNTI (e.g., paging DCI) that indicate the presence of TRS resource sets for the multiple of the number of frames, where the second PDCCH reception is after the first PDCCH reception by a time that is smaller than the multiple of the number of frames. In such examples, the bitmap placement may be similar to the examples in FIGS. 7A and/or 7B.

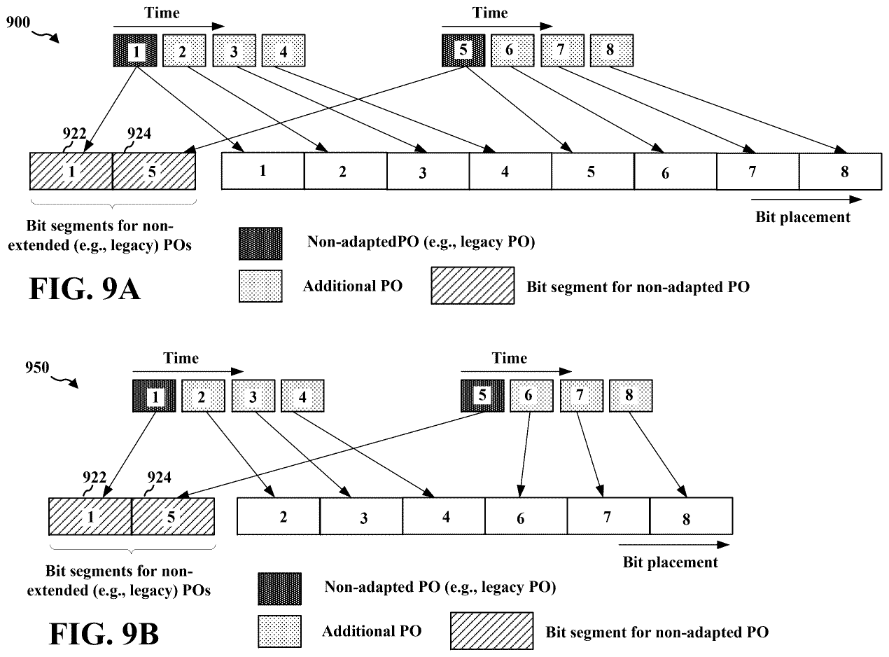

FIG. 9A is a diagram 900 that shows a mapping similar to FIG. 7A with the inclusion of a separation, spacing, or gap between the bitmap segments 922 and 924 for the non-adapted POs and the additional bitmap segments that also map to the additional POs. FIG. 9B is a diagram 950 that shows a mapping similar to FIG. 8A with the inclusion of a separation, spacing, or gap between the bitmap segments 922 and 924 for the non-adapted POs and the additional bitmap segments that also map to the additional POs.

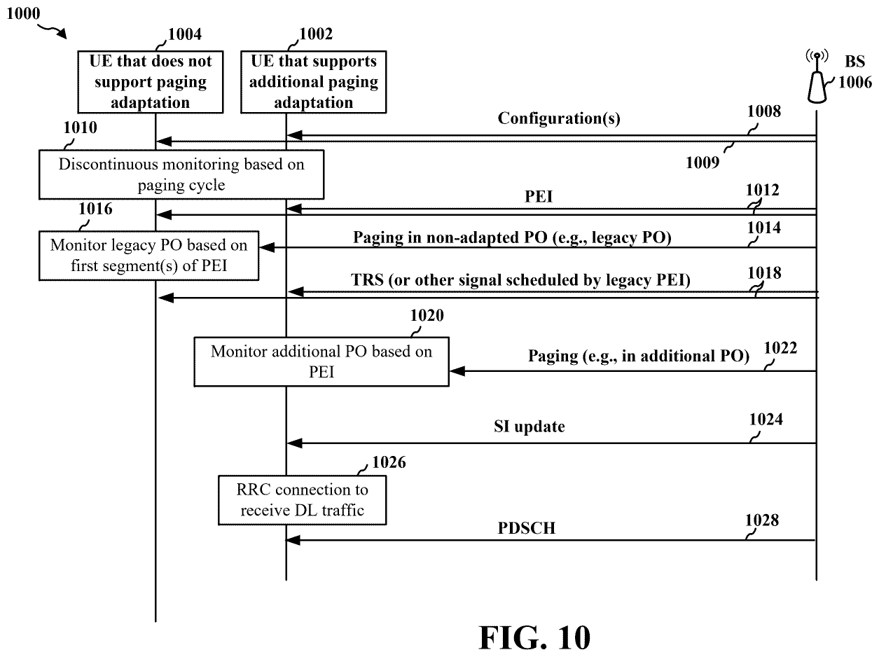

FIG. 10 illustrates an example communication flow 1000 between a network node 1006 and one or more UEs, e.g., the UE 1002 and the UE 1004. Although two UEs are shown to illustrate the concept of two types of UEs, the concepts described herein may be applied for any number of UEs (e.g., including multiple UEs grouped into multiple UE subgroups).

At 1008 and 1010, the network node 1006 transmits one or more configurations to enable the UEs to receive PEI as part of a paging configuration. Although illustrated as two lines, the configuration may be a single configuration or may include separate configurations for UEs of different capabilities (e.g., such as the UE 1002 that supports paging adaptation and the UE 1004 that does not support paging adaptation) The configuration(s) may include any of the paging configuration parameters and/or PEI parameters described herein.

As an example, in some aspects, separate PEI configuration for the additional POs may give the parameters for the additional POs (e.g., and not the non-adapted POs). For example, the number of POnumPerPEI, indicated in the separate configuration may refer to the additional POs without taking into account the non-adapted POs. Similarly, the separate configuration may indicate a separate payload size for DCI2_7 and/or a PEI frame offset that is configured for the additional POs and not the non-adapted POs.

In other aspects, the separate PEI configuration for the additional POs may give the parameters for all of the POs visible to the UE 1002 that supports the paging adaptation, e.g., including parameters for both the legacy and additional POs. For example, the number of POnumPerPEI indicated in the separate configuration may include both legacy and additional POs.

In some examples, whether the separate PEI configuration is for the additional POs without consideration of the non-adapted POs or is based on a combination of the additional POs and the non-adapted POs may depend on whether there is a separate DCI 2_7 for the two types of POs or the PEI for both types of POs are in the same DCI. As an example, if two separate DCIs are used to indicate the PEI separately for the non-adapted POs and the additional POs (e.g., additional POs based on paging adaptation), then the separate configuration for the PEI for the additional POs may be made without reference to the non-adapted POs. If the PEI for both types of POs are carried in a same DCI 2_7, the separate configuration may indicate the parameters based on a combination of the two types of POs.

In some aspects, the parameters configured for PEI, e.g., DCI 2_7 with PEI-RNTI may include one or more of a pei-SearchSpace, pei-FrameOffset, firstPDCCH-MonitoringOccasionOfPEI-O, payloadSizeDCI-2-7, subgroupsNumPerPO, and/or a po-NumPerPEI. In some aspects, when there are separate configurations for the PEI for the non-adapted POs and the PEI for the additional POs, the separate configuration (e.g., for the additional POs) may contain any subset of the above parameters.

In some aspects, if the PEI is included in the same DCI 2_7, the separate configuration may avoid added overhead by not including (e.g., not repeating) a configuration of the search space, frame offset, and first PDCCH for the DCI, as it has already been indicated in the configuration for the non-adapted POs. In contrast, if there are separate DCI 2_7 for the two types of POs, the separate configuration for the additional POs may include the search space configuration, e.g., to enable the UE to separately monitor for the separate DCI 2_7. In some aspects, regardless of whether the PEI is carried in the same DCI 2_7 or a separate DCI 2_7, the additional configuration (e.g., whether separate or indicated in a joint configuration) may indicate at least the payload size for the DCI 2_7 (e.g., which takes into account the added payload for the additional POs), the subgroupNumPerPO (e.g., which may be different than for the non-adapted POs, because there may be a smaller set of UEs that support the paging adaptation), and/or po-NumPerPEI (e.g., to accommodate the additional POs). In some aspects, the separate configuration may be indicated in a separate message. In other aspects, the different parameters may both be included in a combined PEI configuration. For example, the PEI configuration may include a first parameter for po-NumPerPEI for UEs that do not support paging adaptation and a second parameter for po-NumPerPEI for UEs that do support paging adaptation.

For example, the network node 1006 may provide the UEs 1002 and/or 1004 with UE with various information to enable the UEs to detect a DCI format 2_7 while the UE is in RRC_IDLE state or in RRC_INACTIVE state. For example, a search space set may be configured (e.g., by pei-SearchSpace) for the UE to monitor PDCCH for detection of DCI format 2_7 according to a Type2A-PDCCH CSS set. A number of frames may be configured (e.g., by pei-FrameOffset) as an offset from the start of a frame to the start of a first paging frame of paging frames associated with a number of PDCCH monitoring occasions for DCI format 2_7. A number of symbols may be configured (e.g., by firstPDCCH-MonitoringOccasionOfPEI-O) to indicate the number of symbols from the start of the frame to the start of the first PDCCH monitoring occasion for DCI format 2_7. A size of the PEI may be configured (e.g., by payloadSizeDCI-2-7). A number of subgroups per paging occasion,

$${N}_{SG}^{PO} ,$$

may be configured by subgroupsNumPerPO. A number of paging occasions associated with the number of PDCCH monitoring occasions for DCI format 2_7,

$${N}_{PO}^{PEI} ,$$

may be configured by po-NumPerPEI.

A paging indication field of DCI format 2_7 includes

$${N}_{PO}^{PEI}$$

segments of K bits, where

$$K = {N}_{SG}^{PO} .$$

For a subgroup index i_{SG}, 0≤i_{SG}<K, a UE determines a value for the (i_{PO}·K+i_{SG}) bit in the paging indication field, where

$${i}_{PO} = ( ( UE\_IDmodN ) \cdot {N}_{S} + i\_s ) mod {N}_{PO}^{PEI}$$

is a paging occasion index. When the value is ‘l’, the UE monitors the determined paging occasion. Otherwise, the UE is not required to monitor the paging occasion. For example, if the value is “0,” the UE may skip monitoring for paging during the paging occasion.

If

$${N}_{PO}^{PEI} < {N}_{S} ,$$

the number of symbols from the start of the frame to the start of the first PDCCH monitoring occasion for DCI format 2_7 that is associated with paging occasion index i_{PO} is the

$$( ⌊ i\_s / {N}_{PO}^{PEI} ⌋ + 1 ) - th$$

value from the

$${N}_{S} / {N}_{PO}^{PEI}$$

values provided, e.g., by firstPDCCH-MonitoringOccasionOfPEI-O.

Once the UEs 1002 and 1004 receive the paging configurations (e.g., including the PEI configuration(s), the UEs monitor for paging in a discontinuous manner based on the configured paging cycle. For example, FIG. 4A and FIG. 4B illustrate example aspects of a paging cycle. As illustrated at 1012, the network node 1006 may transmit one or more PEI, which is received by the UE 1002 and the UE 1004. The respective UEs are able to interpret the received PEI based on the configurations 1008 and 1009. For example, the PEI may include any of the aspects described in connection with any of FIGS. 5-9B. As the bitmap segments for the non-adapted POs are included at the beginning of the PEI (or in a first PEI), the UE 1004 is able to identify the correct POs that are indicated to monitor for paging, at 1016, in order to receive a paging DCI at 1014 in a non-adapted PO. As well, the UE 1002 uses the PEI configurations to correctly identify the mapping of the bitmap segments to the corresponding POs to monitor at 1020 in order to receive the paging DCI 1022 in a set of POs that includes at least one additional PO. As shown at 1018, a TRS or other signal that is indicated by the PEI may be provided after the PEI for the non-adapted POs, such as illustrated in connection with FIGS. 7B and 8B. In response to receiving paging, the UEs may take any of various actions. In some aspects the paging may include a message in the payload of the paging DCI, such as an emergency message. In some aspects, the paging may indicate for the UE to obtain an SI update, e.g., as shown at 1024. In some aspects, the paging may indicate that the network has downlink traffic for the UE. In response, the UE 1002 may establish (e.g., including re-establish or resume) an RRC connection with the network node 1006, at 1026, in order to receive the downlink traffic. The UE 1002 may then receive PDSCH at 1028. In other aspects, such as for an emergency message, the UE may stay in the RRC idle mode or the RRC inactive mode and continue to discontinuously monitor for paging according to the configured paging cycle.

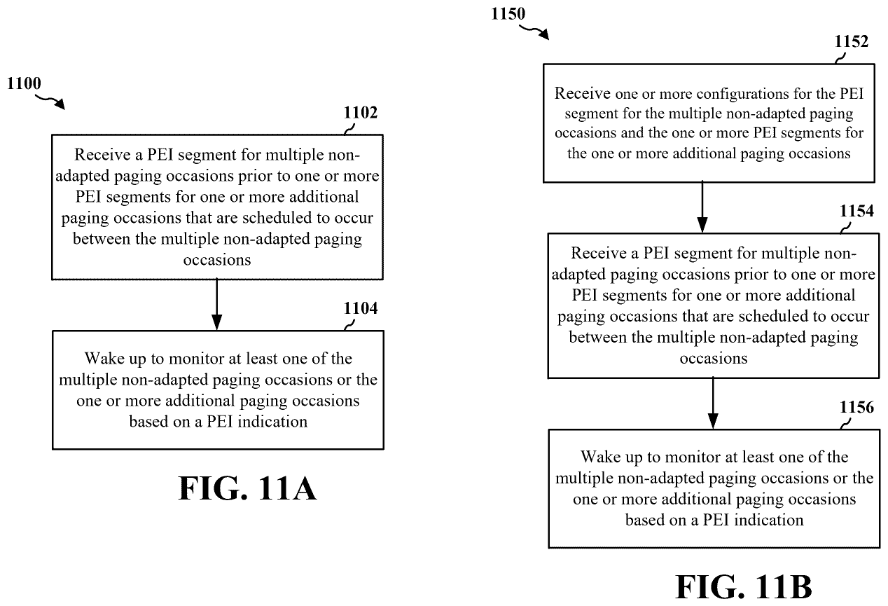

FIG. 11A is a flowchart 1100 of a method of wireless communication. The method may be performed by a UE (e.g., the UE 104, 350, 1002; the apparatus 1304). The method enables paging adaptation while also providing for co-existence with UEs that do not support a paging adaptation capability by enabling both UEs to correctly interpret a PEI bitmap. The aspects presented herein may enable the use of interlaced PO, e.g., including combinations of non-adapted POs that are interlaced with additional POs.

At 1102, the UE receives a PEI segment for multiple non-adapted paging occasions prior to one or more PEI segments for one or more additional paging occasions that are scheduled to occur between the multiple non-adapted paging occasions. The reception may be performed, e.g., by any combination of the paging component 198, the transceiver(s) 1322, and/or the antenna(s) 1380.

At 1104, the UE wakes up to monitor at least one of the multiple non-adapted paging occasions or the one or more additional paging occasions based on a PEI indication. The waking up may be performed, e.g., by any combination of the paging component 198, the transceiver(s) 1322, and/or the antenna(s) 1380. The UE may further receive a paging DCI in the monitored PO(s). The reception may be performed, e.g., by any combination of the paging component 198, the transceiver(s) 1322, and/or the antenna(s) 1380.

In some aspects, the PEI bitmap includes first bitmap locations for the multiple non-adapted paging occasions before second bitmap locations for the one or more additional paging occasions that are scheduled to occur between the multiple non-adapted paging occasions, e.g., as described in connection with any of FIGS. 6-10.

In some aspects, the PEI bitmap includes: a first set of bitmap locations for the multiple non-adapted paging occasions that are non-consecutive in a paging cycle without the one or more additional paging occasions (e.g., based on paging adaptation); and a second set of bitmap locations for consecutive paging occasions that includes a combination of a non-adapted paging occasion and the one or more additional paging occasions, wherein the first set of bitmap locations is before the second set of bitmap locations. FIGS. 7A, 7B, and 9A illustrate examples of PEI with such a mapping.

In some aspects, the PEI bitmap includes a first set of bitmap locations for the multiple non-adapted paging occasions that are non-consecutive in a paging cycle without the one or more additional paging occasions; and a second set of bitmap locations for the one or more additional paging occasions without the multiple non-adapted paging occasions, wherein the first set of bitmap locations is before the second set of bitmap locations. FIGS. 8A, 8B, and 9B illustrate examples of PEI with such a mapping.

In some aspects, the PEI segment for the multiple non-adapted paging occasions is in a joint downlink control information (DCI) with the one or more PEI segments for the one or more additional paging occasions. In some aspects, the PEI segment for the multiple non-adapted paging occasions is in a first downlink control information (DCI), and the one or more PEI segments for the one or more additional paging occasions is in a second DCI that is separate from the first DCI.

In some aspects, the UE may receive one or more configurations for the PEI segment for the multiple non-adapted paging occasions and the one or more PEI segments for the one or more additional paging occasions. FIG. 10 illustrates an example of a UE receiving configuration(s) for paging and/or PEI. In some aspects, the one or more configurations include a first configuration for PEI segment for the multiple non-adapted paging occasions and a second configuration for the one or more PEI segments for the one or more additional paging occasions. For example, the first configuration may include a first number of POs per PEI monitoring occasion (e.g., po-NumPerPEI) for the multiple non-adapted paging occasions, and the second configuration may include a second number of POs per PEI monitoring occasion e.g., po-NumPerPEI) for the one or more additional paging occasions (e.g., and not the non-adapted paging occasions). For example, the second configuration may be applicable only to the adapted paging occasions and not the non-adapted paging occasions. For example, the first configuration may include a first payload size for a downlink control information (DCI) (e.g., payloadSizeDCI-2-7) associated with the multiple non-adapted paging occasions, and the second configuration may include a second payload size for the DCI (e.g., payloadSizeDCI-2-7) associated with the one or more additional paging occasions. As an example, the first configuration may include a first PEI frame offset (e.g., pei-FrameOffset) for the multiple non-adapted paging occasions, and the second configuration may include a second PEI frame offset (e.g., pei-FrameOffset) for the one or more additional paging occasions. In some aspects, the first configuration may include a first number of POs per PEI monitoring occasion, a first payload size for a downlink control information (DCI), and a first PEI frame offset for the multiple non-adapted paging occasions, and the second configuration may include a second number of POs per PEI monitoring occasion, a second payload size for a downlink control information (DCI), and a second PEI frame offset for the one or more additional paging occasions.

In some aspects, the one or more configurations include a single configuration for the PEI segment for the multiple non-adapted paging occasions and the one or more PEI segments for the one or more additional paging occasions. In some aspects, the one or more configurations include: a single configuration if the PEI segment for the multiple non-adapted paging occasions are jointly indicated in a single DCI with the one or more PEI segments for the one or more additional paging occasions, or multiple configurations if the PEI segment for the multiple non-adapted paging occasions are jointly indicated in a separate DCI from the one or more PEI segments for the one or more additional paging occasions.

In some aspects, the bitmap segments for the one or more additional POs may be separated from the bitmap segments for the non-adapted POs. In some aspects, a TRS may be received between the bitmap segments. FIGS. 7B, 8B, 9A, and 9B illustrate example aspects of a separation of the bitmap segments.

FIG. 11B is a flowchart 1150 of a method of wireless communication. The method may be performed by a UE (e.g., the UE 104, 350, 1002; the apparatus 1304). The method enables paging adaptation while also providing for co-existence with UEs that do not support a paging adaptation capability by enabling both UEs to correctly interpret a PEI bitmap. The aspects presented herein may enable the use of interlaced PO, e.g., including combinations of non-adapted POs that are interlaced with additional POs.

At 1152, the UE receives one or more configurations for the PEI segment for the multiple non-adapted paging occasions and the one or more PEI segments for the one or more additional paging occasions. FIG. 10 illustrates an example of a UE receiving configuration(s) for paging and/or PEI. In some aspects, the one or more configurations include a first configuration for PEI segment for the multiple non-adapted paging occasions and a second configuration for the one or more PEI segments for the one or more additional paging occasions. For example, the first configuration may include a first number of POs per PEI monitoring occasion e.g., po-NumPerPEI) for the multiple non-adapted paging occasions, and the second configuration may include a second number of POs per PEI monitoring occasion e.g., po-NumPerPEI) for the one or more additional paging occasions. For example, the first configuration may include a first payload size for a downlink control information (DCI) (e.g., payloadSizeDCI-2-7) associated with the multiple non-adapted paging occasions, and the second configuration may include a second payload size for a DCI (e.g., payloadSizeDCI-2-7) associated with the one or more additional paging occasions. As an example, the first configuration may include a first PEI frame offset (e.g., pei-FrameOffset) for the multiple non-adapted paging occasions, and the second configuration may include a second PEI frame offset (e.g., pei-FrameOffset) for the one or more additional paging occasions. In some aspects, the first configuration may include a first number of POs per PEI monitoring occasion, a first payload size for a downlink control information (DCI), and a first PEI frame offset for the multiple non-adapted paging occasions, and the second configuration may include a second number of POs per PEI monitoring occasion, a second payload size for a downlink control information (DCI), and a second PEI frame offset for the one or more additional paging occasions.

In some aspects, the one or more configurations include a single configuration for the PEI segment for the multiple non-adapted paging occasions and the one or more PEI segments for the one or more additional paging occasions. In some aspects, the one or more configurations include: a single configuration if the PEI segment for the multiple non-adapted paging occasions are jointly indicated in a single DCI with the one or more PEI segments for the one or more additional paging occasions, or multiple configurations if the PEI segment for the multiple non-adapted paging occasions are jointly indicated in a separate DCI from the one or more PEI segments for the one or more additional paging occasions.

At 1154, the UE receives a PEI segment for multiple non-adapted paging occasions prior to one or more PEI segments for one or more additional paging occasions that are scheduled to occur between the multiple non-adapted paging occasions. The reception may be performed, e.g., by any combination of the paging component 198, the transceiver(s) 1322, and/or the antenna(s) 1380.

At 1156, the UE wakes up to monitor at least one of the multiple non-adapted paging occasions or the one or more additional paging occasions based on a PEI indication. The waking up may be performed, e.g., by any combination of the paging component 198, the transceiver(s) 1322, and/or the antenna(s) 1380. The UE may further receive a paging DCI in the monitored PO(s). The reception may be performed, e.g., by any combination of the paging component 198, the transceiver(s) 1322, and/or the antenna(s) 1380.

In some aspects, the PEI bitmap includes first bitmap locations for the multiple non-adapted paging occasions before second bitmap locations for the one or more additional paging occasions that are scheduled to occur between the multiple non-adapted paging occasions, e.g., as described in connection with any of FIGS. 6-10.

In some aspects, the PEI bitmap includes: a first set of bitmap locations for the multiple non-adapted paging occasions that are non-consecutive in a paging cycle without the one or more additional paging occasions (e.g., based on paging adaptation); and a second set of bitmap locations for consecutive paging occasions that includes a combination of a non-adapted paging occasion and the one or more additional paging occasions, wherein the first set of bitmap locations is before the second set of bitmap locations. FIGS. 7A, 7B, and 9A illustrate examples of PEI with such a mapping.

In some aspects, the PEI bitmap includes a first set of bitmap locations for the multiple non-adapted paging occasions that are non-consecutive in a paging cycle without the one or more additional paging occasions; and a second set of bitmap locations for the one or more additional paging occasions without the multiple non-adapted paging occasions, wherein the first set of bitmap locations is before the second set of bitmap locations. FIGS. 8A, 8B, and 9B illustrate examples of PEI with such a mapping.

In some aspects, the PEI segment for the multiple non-adapted paging occasions is in a joint downlink control information (DCI) with the one or more PEI segments for the one or more additional paging occasions. In some aspects, the PEI segment for the multiple non-adapted paging occasions is in a first downlink control information (DCI), and the one or more PEI segments for the one or more additional paging occasions is in a second DCI that is separate from the first DCI.

In some aspects, the bitmap segments for the one or more additional POs may be separated from the bitmap segments for the non-adapted POs. In some aspects, a TRS may be received between the bitmap segments. FIGS. 7B, 8B, 9A, and 9B illustrate example aspects of a separation of the bitmap segments.

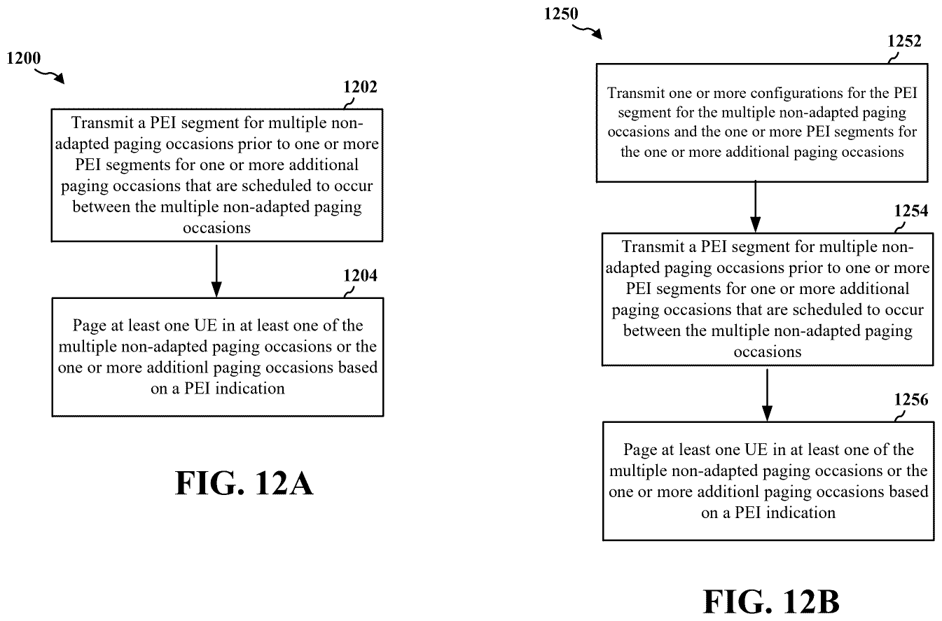

FIG. 12A is a flowchart 1200 of a method of wireless communication. The method may be performed by a network node such as a base station or one or more components of a base station (e.g., the base station 102, 310; the network node 1006; the network entity 1402). The method enables paging adaptation while also providing for co-existence with UEs that do not support a paging adaptation capability by enabling both UEs to correctly interpret a PEI bitmap. The aspects presented herein may enable the use of interlaced PO, e.g., including combinations of non-adapted POs that are interlaced with additional POs.

At 1202, the network node transmits a paging early indication (PEI) segment for multiple non-adapted paging occasions prior to one or more PEI segments for one or more additional paging occasions that are scheduled to occur between the multiple non-adapted paging occasions. The transmission may be performed, e.g., by the paging component 199, the transceiver(s) 1446, and/or the antenna(s) 1480.

At 1204, the network node pages at least one user equipment (UE) in at least one of the multiple non-adapted paging occasions or the one or more additional paging occasions based on a PEI indication. The paging may be performed, e.g., by the paging component 199, the transceiver(s) 1446, and/or the antenna(s) 1480.

In some aspects, the PEI bitmap includes first bitmap locations for the multiple non-adapted paging occasions before second bitmap locations for the one or more additional paging occasions that are scheduled to occur between the multiple non-adapted paging occasions, e.g., as described in connection with any of FIGS. 6-10.

In some aspects, the PEI bitmap includes: a first set of bitmap locations for the multiple non-adapted paging occasions that are non-consecutive in a paging cycle without the one or more additional paging occasions; and a second set of bitmap locations for consecutive paging occasions that includes a combination of a non-adapted paging occasion and the one or more additional paging occasions, wherein the first set of bitmap locations is before the second set of bitmap locations. FIGS. 7A, 7B, and 9A illustrate examples of PEI with such a mapping.

In some aspects, the PEI bitmap includes a first set of bitmap locations for the multiple non-adapted paging occasions that are non-consecutive in a paging cycle without the one or more additional paging occasions; and a second set of bitmap locations for the one or more additional paging occasions without the multiple non-adapted paging occasions, wherein the first set of bitmap locations is before the second set of bitmap locations. FIGS. 8A, 8B, and 9B illustrate examples of PEI with such a mapping.

In some aspects, the PEI segment for the multiple non-adapted paging occasions is in a joint downlink control information (DCI) with the one or more PEI segments for the one or more additional paging occasions. In some aspects, the PEI segment for the multiple non-adapted paging occasions is in a first downlink control information (DCI), and the one or more PEI segments for the one or more additional paging occasions is in a second DCI that is separate from the first DCI.

In some aspects, the network node may transmit one or more configurations for the PEI segment for the multiple non-adapted paging occasions and the one or more PEI segments for the one or more additional paging occasions. FIG. 10 illustrates an example of a network node sending configuration(s) for paging and/or PEI. In some aspects, the one or more configurations include a first configuration for PEI segment for the multiple non-adapted paging occasions and a second configuration for the one or more PEI segments for the one or more additional paging occasions. For example, the first configuration may include a first number of POs per PEI monitoring occasion for the multiple non-adapted paging occasions, and the second configuration may include a second number of POs per PEI monitoring occasion for the one or more additional paging occasions. For example, the first configuration may include a first payload size for a downlink control information (DCI) associated with the multiple non-adapted paging occasions, and the second configuration may include a second payload size for the DCI associated with the one or more additional paging occasions. As an example, the first configuration may include a first PEI frame offset for the multiple non-adapted paging occasions, and the second configuration may include a second PEI frame offset for the one or more additional paging occasions. In some aspects, the first configuration may include a first number of POs per PEI monitoring occasion, a first payload size for a downlink control information (DCI), and a first PEI frame offset for the multiple non-adapted paging occasions, and the second configuration may include a second number of POs per PEI monitoring occasion, a second payload size for a downlink control information (DCI), and a second PEI frame offset for the one or more additional paging occasions.

In some aspects, the one or more configurations include a single configuration for the PEI segment for the multiple non-adapted paging occasions and the one or more PEI segments for the one or more additional paging occasions. In some aspects, the one or more configurations include: a single configuration if the PEI segment for the multiple non-adapted paging occasions are jointly indicated in a single DCI with the one or more PEI segments for the one or more additional paging occasions, or multiple configurations if the PEI segment for the multiple non-adapted paging occasions are jointly indicated in a separate DCI from the one or more PEI segments for the one or more additional paging occasions.

In some aspects, the bitmap segments for the one or more additional POs may be separated from the bitmap segments for the non-adapted POs. In some aspects, a TRS may be received between the bitmap segments. FIGS. 7B, 8B, 9A, and 9B illustrate example aspects of a separation of the bitmap segments.

FIG. 12B is a flowchart 1250 of a method of wireless communication. The method may be performed by a network node such as a base station or one or more components of a base station (e.g., the base station 102, 310; the network node 1006; the network entity 1402). The method enables paging adaptation while also providing for co-existence with UEs that do not support a paging adaptation capability by enabling both UEs to correctly interpret a PEI bitmap. The aspects presented herein may enable the use of interlaced PO, e.g., including combinations of non-adapted POs that are interlaced with additional POs.

At 1252, the network node transmits one or more configurations for the PEI segment for the multiple non-adapted paging occasions and the one or more PEI segments for the one or more additional paging occasions. FIG. 10 illustrates an example of a network node sending configuration(s) for paging and/or PEI. In some aspects, the one or more configurations include a first configuration for PEI segment for the multiple non-adapted paging occasions and a second configuration for the one or more PEI segments for the one or more additional paging occasions. For example, the first configuration may include a first number of POs per PEI monitoring occasion for the multiple non-adapted paging occasions, and the second configuration may include a second number of POs per PEI monitoring occasion for the one or more additional paging occasions. For example, the first configuration may include a first payload size for a downlink control information (DCI) associated with the multiple non-adapted paging occasions, and the second configuration may include a second payload size for the DCI associated with the one or more additional paging occasions. As an example, the first configuration may include a first PEI frame offset for the multiple non-adapted paging occasions, and the second configuration may include a second PEI frame offset for the one or more additional paging occasions. In some aspects, the first configuration may include a first number of POs per PEI monitoring occasion, a first payload size for a downlink control information (DCI), and a first PEI frame offset for the multiple non-adapted paging occasions, and the second configuration may include a second number of POs per PEI monitoring occasion, a second payload size for a downlink control information (DCI), and a second PEI frame offset for the one or more additional paging occasions.

In some aspects, the one or more configurations include a single configuration for the PEI segment for the multiple non-adapted paging occasions and the one or more PEI segments for the one or more additional paging occasions. In some aspects, the one or more configurations include: a single configuration if the PEI segment for the multiple non-adapted paging occasions are jointly indicated in a single DCI with the one or more PEI segments for the one or more additional paging occasions, or multiple configurations if the PEI segment for the multiple non-adapted paging occasions are jointly indicated in a separate DCI from the one or more PEI segments for the one or more additional paging occasions.

At 1254, the network node transmits a paging early indication (PEI) segment for multiple non-adapted paging occasions prior to one or more PEI segments for one or more additional paging occasions that are scheduled to occur between the multiple non-adapted paging occasions. The transmission may be performed, e.g., by the paging component 199, the transceiver(s) 1446, and/or the antenna(s) 1480.

At 1256, the network node pages at least one user equipment (UE) in at least one of the multiple non-adapted paging occasions or the one or more additional paging occasions based on a PEI indication. The paging may be performed, e.g., by the paging component 199, the transceiver(s) 1446, and/or the antenna(s) 1480.

In some aspects, the PEI bitmap includes first bitmap locations for the multiple non-adapted paging occasions before second bitmap locations for the one or more additional paging occasions that are scheduled to occur between the multiple non-adapted paging occasions, e.g., as described in connection with any of FIGS. 6-10.

In some aspects, the PEI bitmap includes: a first set of bitmap locations for the multiple non-adapted paging occasions that are non-consecutive in a paging cycle without the one or more additional paging occasions; and a second set of bitmap locations for consecutive paging occasions that includes a combination of a non-adapted paging occasion and the one or more additional paging occasions, wherein the first set of bitmap locations is before the second set of bitmap locations. FIGS. 7A, 7B, and 9A illustrate examples of PEI with such a mapping.

In some aspects, the PEI bitmap includes a first set of bitmap locations for the multiple non-adapted paging occasions that are non-consecutive in a paging cycle without the one or more additional paging occasions; and a second set of bitmap locations for the one or more additional paging occasions without the multiple non-adapted paging occasions, wherein the first set of bitmap locations is before the second set of bitmap locations. FIGS. 8A, 8B, and 9B illustrate examples of PEI with such a mapping.

In some aspects, the PEI segment for the multiple non-adapted paging occasions is in a joint downlink control information (DCI) with the one or more PEI segments for the one or more additional paging occasions. In some aspects, the PEI segment for the multiple non-adapted paging occasions is in a first downlink control information (DCI), and the one or more PEI segments for the one or more additional paging occasions is in a second DCI that is separate from the first DCI.

In some aspects, the bitmap segments for the one or more additional POs may be separated from the bitmap segments for the non-adapted POs. In some aspects, a TRS may be received between the bitmap segments. FIGS. 7B, 8B, 9A, and 9B illustrate example aspects of a separation of the bitmap segments.

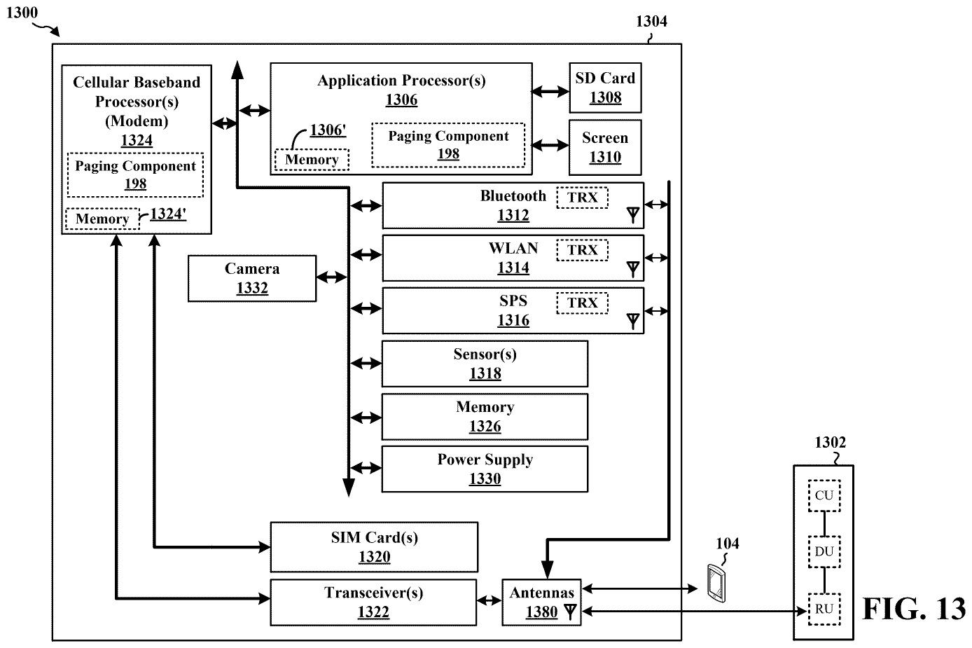

FIG. 13 is a diagram 1300 illustrating an example of a hardware implementation for an apparatus 1304. The apparatus 1304 may be a UE, a component of a UE, or may implement UE functionality. In some aspects, the apparatus 1304 may include at least one cellular baseband processor 1324 (also referred to as a modem) coupled to one or more transceivers 1322 (e.g., cellular RF transceiver). The cellular baseband processor(s) 1324 may include at least one on-chip memory 1324′. In some aspects, the apparatus 1304 may further include one or more subscriber identity modules (SIM) cards 1320 and at least one application processor 1306 coupled to a secure digital (SD) card 1308 and a screen 1310. The application processor(s) 1306 may include on-chip memory 1306′. In some aspects, the apparatus 1304 may further include a Bluetooth module 1312, a WLAN module 1314, an SPS module 1316 (e.g., GNSS module), one or more sensor modules 1318 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1326, a power supply 1330, and/or a camera 1332. The Bluetooth module 1312, the WLAN module 1314, and the SPS module 1316 may include an on-chip transceiver (TRX) (or in some cases, just a receiver (RX)). The Bluetooth module 1312, the WLAN module 1314, and the SPS module 1316 may include their own dedicated antennas and/or utilize the antennas 1380 for communication. The cellular baseband processor(s) 1324 communicates through the transceiver(s) 1322 via one or more antennas 1380 with the UE 104 and/or with an RU associated with a network entity 1302. The cellular baseband processor(s) 1324 and the application processor(s) 1306 may each include a computer-readable medium/memory 1324′, 1306′, respectively. The additional memory modules 1326 may also be considered a computer-readable medium/memory. Each computer-readable medium/memory 1324′, 1306′, 1326 may be non-transitory. The cellular baseband processor(s) 1324 and the application processor(s) 1306 are each responsible for general processing, including the execution of software stored on the computer-readable medium/memory. The software, when executed by the cellular baseband processor(s) 1324/application processor(s) 1306, causes the cellular baseband processor(s) 1324/application processor(s) 1306 to perform the various functions described supra. The cellular baseband processor(s) 1324 and the application processor(s) 1306 are configured to perform the various functions described supra based at least in part of the information stored in the memory. That is, the cellular baseband processor(s) 1324 and the application processor(s) 1306 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 1324/application processor(s) 1306 when executing software. The cellular baseband processor(s) 1324/application processor(s) 1306 may be a component of the UE 350 and may include the at least one memory 360 and/or at least one of the TX processor 368, the RX processor 356, and the controller/processor 359. In one configuration, the apparatus 1304 may be at least one processor chip (modem and/or application) and include just the cellular baseband processor(s) 1324 and/or the application processor(s) 1306, and in another configuration, the apparatus 1304 may be the entire UE (e.g., see UE 350 of FIG. 3) and include the additional modules of the apparatus 1304.

As discussed supra, the component 198 may be configured to receive a PEI segment for multiple non-adapted paging occasions prior to one or more PEI segments for one or more additional paging occasions that are scheduled to occur between the multiple non-adapted paging occasions; and wake up to monitor at least one of the multiple non-adapted paging occasions or the one or more additional paging occasions based on a PEI indication. In some aspects, the paging component 198 and/or the apparatus 1304 are further configured to receive one or more configurations for the PEI segment for the multiple non-adapted paging occasions and the one or more PEI segments for the one or more additional paging occasions. The apparatus 1304 may be further configured to perform any of the aspects described in connection with the flowchart in FIG. 11A, FIG. 11B, and/or performed by the UE in the communication flow of FIG. 10. The component 198 may be within the cellular baseband processor(s) 1324, the application processor(s) 1306, or both the cellular baseband processor(s) 1324 and the application processor(s) 1306. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1304 may include a variety of components configured for various functions. In one configuration, the apparatus 1304, and in particular the cellular baseband processor(s) 1324 and/or the application processor(s) 1306, may include means for receiving a PEI segment for multiple non-adapted paging occasions prior to one or more PEI segments for one or more additional paging occasions that are scheduled to occur between the multiple non-adapted paging occasions; and means for waking up to monitor at least one of the multiple non-adapted paging occasions or the one or more additional paging occasions based on a PEI indication. In some aspects, the apparatus 1304 further includes means for receiving one or more configurations for the PEI segment for the multiple non-adapted paging occasions and the one or more PEI segments for the one or more additional paging occasions. The apparatus 1304 may be further include means for performing any of the aspects described in connection with the flowchart in FIG. 11A, FIG. 11B, and/or performed by the UE in the communication flow of FIG. 10. The means may be the component 198 of the apparatus 1304 configured to perform the functions recited by the means. As described supra, the apparatus 1304 may include the TX processor 368, the RX processor 356, and the controller/processor 359. As such, in one configuration, the means may be the TX processor 368, the RX processor 356, and/or the controller/processor 359 configured to perform the functions recited by the means.

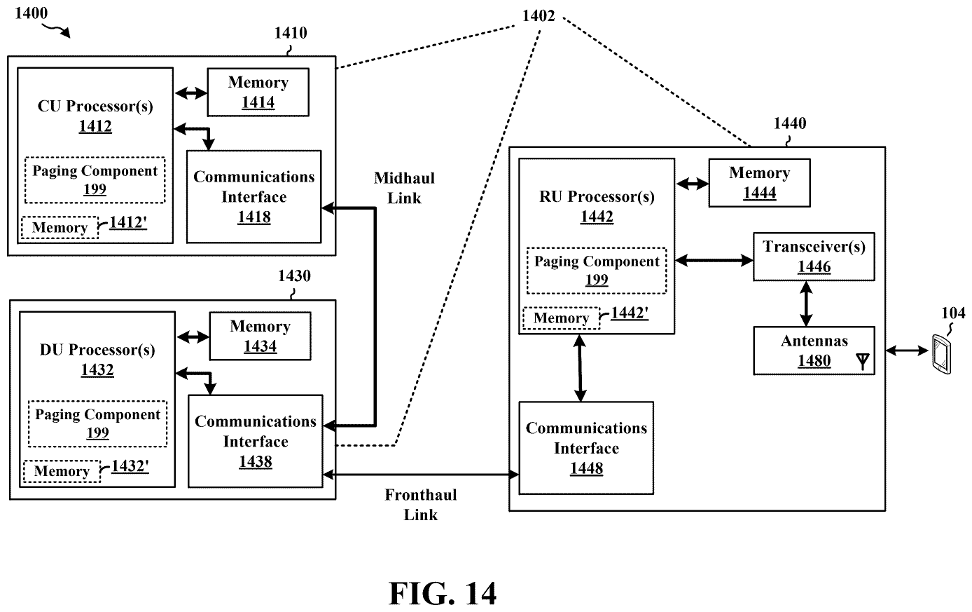

FIG. 14 is a diagram 1400 illustrating an example of a hardware implementation for a network entity 1402. The network entity 1402 may be a BS, a component of a BS, or may implement BS functionality. The network entity 1402 may include at least one of a CU 1410, a DU 1430, or an RU 1440. For example, depending on the layer functionality handled by the component 199, the network entity 1402 may include the CU 1410; both the CU 1410 and the DU 1430; each of the CU 1410, the DU 1430, and the RU 1440; the DU 1430; both the DU 1430 and the RU 1440; or the RU 1440. The CU 1410 may include at least one CU processor 1412. The CU processor(s) 1412 may include on-chip memory 1412′. In some aspects, the CU 1410 may further include additional memory modules 1414 and a communications interface 1418. The CU 1410 communicates with the DU 1430 through a midhaul link, such as an F1 interface. The DU 1430 may include at least one DU processor 1432. The DU processor(s) 1432 may include on-chip memory 1432′. In some aspects, the DU 1430 may further include additional memory modules 1434 and a communications interface 1438. The DU 1430 communicates with the RU 1440 through a fronthaul link. The RU 1440 may include at least one RU processor 1442. The RU processor(s) 1442 may include on-chip memory 1442′. In some aspects, the RU 1440 may further include additional memory modules 1444, one or more transceivers 1446, antennas 1480, and a communications interface 1448. The RU 1440 communicates with the UE 104. The on-chip memory 1412′, 1432′, 1442′ and the additional memory modules 1414, 1434, 1444 may each be considered a computer-readable medium/memory. Each computer-readable medium/memory may be non-transitory. Each of the processors 1412, 1432, 1442 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to transmit a paging early indication (PEI) segment for multiple non-adapted paging occasions prior to one or more PEI segments for one or more additional paging occasions that are scheduled to occur between the multiple non-adapted paging occasions; and page at least one user equipment (UE) in at least one of the multiple non-adapted paging occasions or the one or more additional paging occasions based on a PEI indication. In some aspects, the paging component 199 and/or the network entity may be further configured to provide one or more configurations for the PEI segment for the multiple non-adapted paging occasions and the one or more PEI segments for the one or more additional paging occasions. The network entity 1402 may be further configured to perform any of the aspects described in connection with the flowchart in FIG. 12A, FIG. 12B, and/or performed by the network node in the communication flow of FIG. 10. The component 199 may be within one or more processors of one or more of the CU 1410, DU 1430, and the RU 1440. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1402 may include a variety of components configured for various functions. In one configuration, the network entity 1402 may include means for transmitting a paging early indication (PEI) segment for multiple non-adapted paging occasions prior to one or more PEI segments for one or more additional paging occasions that are scheduled to occur between the multiple non-adapted paging occasions; and means for paging at least one user equipment (UE) in at least one of the multiple non-adapted paging occasions or the one or more additional paging occasions based on a PEI indication. In some aspects, the network entity may further include means for configuring one or more configurations for the PEI segment for the multiple non-adapted paging occasions and the one or more PEI segments for the one or more additional paging occasions. The network entity 1402 may be further include means for performing any of the aspects described in connection with the flowchart in FIG. 12A, FIG. 12B, and/or performed by the network node in the communication flow of FIG. 10. The means may be the component 199 of the network entity 1402 configured to perform the functions recited by the means. As described supra, the network entity 1402 may include the TX processor 316, the RX processor 370, and the controller/processor 375. As such, in one configuration, the means may be the TX processor 316, the RX processor 370, and/or the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor (i.e., a set of one or more processors P) is configured to perform a set of functions F, each processor of P may be configured to perform a subset S of F, where S⊆F. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” or “based on or otherwise in association with” unless specifically recited differently. As used herein, the phrase “associated with” encompasses any association, relation, or connection link. Among other examples, the phrase “associated with” may include in association with, based on, based at least in part on, corresponding to, related to, in response to, linked with, and/or connected with. As used herein, “using” may include any use, which may include any consideration, any calculation, and/or any dependency, among examples of use.

The following aspects are illustrative only and may be combined with other aspects or teachings described herein, without limitation.

Aspect 1 is a method of wireless communication at a user equipment (UE), comprising: receiving a paging early indication (PEI) segment for multiple non-adapted paging occasions prior to one or more PEI segments for one or more additional paging occasions that are scheduled to occur between the multiple non-adapted paging occasions; and waking up to monitor at least one of the multiple non-adapted paging occasions or the one or more additional paging occasions based on a PEI indication.

In aspect 2, the method of aspect 1 further includes that a PEI bitmap includes first bitmap locations for the multiple non-adapted paging occasions before second bitmap locations for the one or more additional paging occasions that are scheduled to occur between the multiple non-adapted paging occasions.

In aspect 3, the method of aspect 2 further includes that the second bitmap locations are spaced from the first bitmap locations.

In aspect 4, the method of any of aspects 1-3 further includes that a tracking reference signal (TRS) is included between the first bitmap locations and the second bitmap locations.

In aspect 5, the method of any of aspects 1-4 further includes that at least one bit in the first bitmap locations indicates a presence of a signal, and wherein the second bitmap locations are spaced from the first bitmap locations based on the presence of the signal.

In aspect 6, the method of any of aspects 1-5 further includes that a first set of bitmap locations for the multiple non-adapted paging occasions that are non-consecutive in a paging cycle without the one or more additional paging occasions; and a second set of bitmap locations for consecutive paging occasions that includes a combination of a non-adapted paging occasion and the one or more additional paging occasions, wherein the first set of bitmap locations is before the second set of bitmap locations.

In aspect 7, the method of any of aspects 1-5 further includes that a PEI bitmap includes: a first set of bitmap locations for the multiple non-adapted paging occasions that are non-consecutive in a paging cycle without the one or more additional paging occasions; and a second set of bitmap locations for the one or more additional paging occasions without the multiple non-adapted paging occasions, wherein the first set of bitmap locations is before the second set of bitmap locations.

In aspect 8, the method of any of aspects 1-7 further includes that the PEI segment for the multiple non-adapted paging occasions is in a joint downlink control information (DCI) with the one or more PEI segments for the one or more additional paging occasions.

In aspect 9, the method of any of aspects 1-7 further includes that the PEI segment for the multiple non-adapted paging occasions is in a first downlink control information (DCI), and the one or more PEI segments for the one or more additional paging occasions is in a second DCI that is separate from the first DCI.

In aspect 10, the method of any of aspects 1-9 further includes receiving one or more configurations for the PEI segment for the multiple non-adapted paging occasions and the one or more PEI segments for the one or more additional paging occasions.

In aspect 11, the method of aspect 10 further includes that the one or more configurations include a first configuration for PEI segment for the multiple non-adapted paging occasions and a second configuration for the one or more PEI segments for the one or more additional paging occasions.

In aspect 12, the method of aspect 11 further includes that the first configuration includes a first number of POs per PEI monitoring occasion for the multiple non-adapted paging occasions, and the second configuration includes a second number of POs per PEI monitoring occasion for the one or more additional paging occasions.

In aspect 13, the method of aspect 11 or 12 further includes that the first configuration includes a first payload size for a downlink control information (DCI) associated with the multiple non-adapted paging occasions, and the second configuration includes a second payload size for the DCI associated with the one or more additional paging occasions.

In aspect 14, the method of any of aspects 11-13 further includes that the first configuration includes a first PEI frame offset for the multiple non-adapted paging occasions, and the second configuration includes a second PEI frame offset for the one or more additional paging occasions.

In aspect 15, the method of aspect 11 further includes that the first configuration includes a first number of POs per PEI monitoring occasion, a first payload size for a downlink control information (DCI), and a first PEI frame offset for the multiple non-adapted paging occasions, and the second configuration includes a second number of POs per PEI monitoring occasion, a second payload size for the DCI, and a second PEI frame offset for the one or more additional paging occasions.

In aspect 16, the method of aspect 10 further includes that the one or more configurations include a single configuration for the PEI segment for the multiple non-adapted paging occasions and the one or more PEI segments for the one or more additional paging occasions.

In aspect 17, the method of aspect 10 further includes that the one or more configurations include: a single configuration if the PEI segment for the multiple non-adapted paging occasions are jointly indicated in a single DCI with the one or more PEI segments for the one or more additional paging occasions, or multiple configurations if the PEI segment for the multiple non-adapted paging occasions are jointly indicated in a separate DCI from the one or more PEI segments for the one or more additional paging occasions.

Aspect 18 is an apparatus for wireless communication at a UE, comprising: at least one memory; and at least one processor coupled to the at least one memory, the at least one processor is configured to perform the method of any of aspects 1-17.

Aspect 19 is an apparatus for wireless communication at a UE, comprising: one or more memories; and one or more processors coupled to the one or more memories and configured to: perform the method of any of aspects 1-17.

Aspect 20 is an apparatus for wireless communication at a UE, comprising: memory circuitry; and processor circuitry coupled to the memory circuitry and configured to: perform the method of any of aspects 1-17.

Aspect 21 is an apparatus for wireless communication at a UE, comprising means for performing each step in the method of any of aspects 1-17.

Aspect 22 is the apparatus of any of aspects 18 to 21, further comprising a transceiver configured to receive or to transmit in association with the method of any of aspects 1-17.

Aspect 23 is a computer-readable medium storing computer executable code at a UE, the code when executed by at least one processor causes the at least one processor to perform the method of any of aspects 1-17.

Aspect 24 is a method of wireless communication at a network node, comprising: transmitting a paging early indication (PEI) segment for multiple non-adapted paging occasions prior to one or more PEI segments for one or more additional paging occasions that are scheduled to occur between the multiple non-adapted paging occasions; and paging at least one user equipment (UE) in at least one of the multiple non-adapted paging occasions or the one or more additional paging occasions based on a PEI indication.

In aspect 25, the method of aspect 24 further includes that a PEI bitmap includes first bitmap locations for the multiple non-adapted paging occasions before second bitmap locations for the one or more additional paging occasions that are scheduled to occur between the multiple non-adapted paging occasions.

In aspect 26, the method of aspect 25 further includes that the second bitmap locations are spaced from the first bitmap locations.

In aspect 27, the method of any of aspects 24-26 further includes that a tracking reference signal (TRS) is included between the first bitmap locations and the second bitmap locations.

In aspect 28, the method of any of aspects 24-27 further includes that at least one bit in the first bitmap locations indicates a presence of a signal, and wherein the second bitmap locations are spaced from the first bitmap locations based on the presence of the signal.

In aspect 29, the method of any of aspects 24-28 further includes that a PEI bitmap includes: a first set of bitmap locations for the multiple non-adapted paging occasions that are non-consecutive in a paging cycle without the one or more additional paging occasions; and a second set of bitmap locations for consecutive paging occasions that includes a combination of a non-adapted paging occasion and the one or more additional paging occasions, wherein the first set of bitmap locations is before the second set of bitmap locations.

In aspect 30, the method of any of aspects 24-28 further includes that a PEI bitmap includes: a first set of bitmap locations for the multiple non-adapted paging occasions that are non-consecutive in a paging cycle without the one or more additional paging occasions; and a second set of bitmap locations for the one or more additional paging occasions without the multiple non-adapted paging occasions, wherein the first set of bitmap locations is before the second set of bitmap locations.

In aspect 31, the method of any of aspects 24-30 further includes that the PEI segment for the multiple non-adapted paging occasions is in a joint downlink control information (DCI) with the one or more PEI segments for the one or more additional paging occasions.

In aspect 32, the method of any of aspects 24-30 further includes that the PEI segment for the multiple non-adapted paging occasions is in a first downlink control information (DCI), and the one or more PEI segments for the one or more additional paging occasions is in a second DCI that is separate from the first DCI.

In aspect 33, the method of any of aspects 24-32 further includes providing one or more configurations for the PEI segment for the multiple non-adapted paging occasions and the one or more PEI segments for the one or more additional paging occasions.

In aspect 34, the method of aspect 33 further includes that the one or more configurations include a first configuration for PEI segment for the multiple non-adapted paging occasions and a second configuration for the one or more PEI segments for the one or more additional paging occasions.

In aspect 35, the method of aspect 34 further includes that the first configuration includes a first number of POs per PEI monitoring occasion for the multiple non-adapted paging occasions, and the second configuration includes a second number of POs per PEI monitoring occasion for the one or more additional paging occasions.

In aspect 36, the method of aspect 34 or 35 further includes that the first configuration includes a first payload size for a downlink control information (DCI) associated with the multiple non-adapted paging occasions, and the second configuration includes a second payload size for the DCI associated with the one or more additional paging occasions.

In aspect 37, the method of any of aspects 34-36 further includes that the first configuration includes a first PEI frame offset for the multiple non-adapted paging occasions, and the second configuration includes a second PEI frame offset for the one or more additional paging occasions.

In aspect 38, the method of aspect 34 further includes that the first configuration includes a first number of POs per PEI monitoring occasion, a first payload size for a downlink control information (DCI), and a first PEI frame offset for the multiple non-adapted paging occasions, and the second configuration includes a second number of POs per PEI monitoring occasion, a second payload size for the DCI, and a second PEI frame offset for the one or more additional paging occasions.

In aspect 39, the method of aspect 34 further includes that the one or more configurations include a single configuration for the PEI segment for the multiple non-adapted paging occasions and the one or more PEI segments for the one or more additional paging occasions.

In aspect 40, the method of aspect 34 further includes that the one or more configurations include: a single configuration if the PEI segment for the multiple non-adapted paging occasions are jointly indicated in a single DCI with the one or more PEI segments for the one or more additional paging occasions, or multiple configurations if the PEI segment for the multiple non-adapted paging occasions are jointly indicated in a separate DCI from the one or more PEI segments for the one or more additional paging occasions.

Aspect 41 is an apparatus for wireless communication at a network node, comprising: at least one memory; and at least one processor coupled to the at least one memory, the at least one processor is configured to perform the method of any of aspects 24-40.

Aspect 42 is an apparatus for wireless communication at a network node, comprising: one or more memories; and one or more processors coupled to the one or more memories and configured to: perform the method of any of aspects 24-40.

Aspect 43 is an apparatus for wireless communication at a network node, comprising: memory circuitry; and processor circuitry coupled to the memory circuitry and configured to: perform the method of any of aspects 24-40.

Aspect 44 is an apparatus for wireless communication at a network node, comprising means for performing each step in the method of any of aspects 24-40.

Aspect 45 is the apparatus of any of aspects 41 to 44, further comprising a transceiver configured to receive or to transmit in association with the method of any of aspects 24-40.

Aspect 46 is a computer-readable medium storing computer executable code at a network node, the code when executed by at least one processor causes the at least one processor to perform the method of any of aspects 24-40.

What is claimed is:

1. An apparatus for wireless communication at a user equipment (UE), comprising:
at least one memory; and
at least one processor coupled to the at least one memory and, based at least in part on information stored in the at least one memory, the at least one processor is configured to:
receive a paging early indication (PEI) segment for multiple non-adapted paging occasions prior to one or more PEI segments for one or more additional paging occasions that are scheduled to occur between the multiple non-adapted paging occasions; and
wake up to monitor at least one of the multiple non-adapted paging occasions or the one or more additional paging occasions based on a PEI indication.

2. The apparatus of claim 1, wherein a PEI bitmap includes first bitmap locations for the multiple non-adapted paging occasions before second bitmap locations for the one or more additional paging occasions that are scheduled to occur between the multiple non-adapted paging occasions.

3. The apparatus of claim 2, wherein the second bitmap locations are spaced from the first bitmap locations.

4. The apparatus of claim 3, wherein a tracking reference signal (TRS) is included between the first bitmap locations and the second bitmap locations, or
wherein at least one bit in the first bitmap locations indicates a presence of a signal, and wherein the second bitmap locations are spaced from the first bitmap locations based on the presence of the signal.

5. The apparatus of claim 1, wherein a PEI bitmap includes:
a first set of bitmap locations for the multiple non-adapted paging occasions that are non-consecutive in a paging cycle without the one or more additional paging occasions; and
a second set of bitmap locations for consecutive paging occasions that includes a combination of a non-adapted paging occasion and the one or more additional paging occasions, wherein the first set of bitmap locations is before the second set of bitmap locations.

6. The apparatus of claim 1, wherein a PEI bitmap includes:
a first set of bitmap locations for the multiple non-adapted paging occasions that are non-consecutive in a paging cycle without the one or more additional paging occasions; and
a second set of bitmap locations for the one or more additional paging occasions without the multiple non-adapted paging occasions, wherein the first set of bitmap locations is before the second set of bitmap locations.

7. The apparatus of claim 1, wherein the PEI segment for the multiple non-adapted paging occasions is in a joint downlink control information (DCI) with the one or more PEI segments for the one or more additional paging occasions, or
wherein the PEI segment for the multiple non-adapted paging occasions is in a first downlink control information (DCI), and the one or more PEI segments for the one or more additional paging occasions is in a second DCI that is separate from the first DCI.

8. The apparatus of claim 1, wherein the at least one processor is further configured to:
receive one or more configurations for the PEI segment for the multiple non-adapted paging occasions and the one or more PEI segments for the one or more additional paging occasions.

9. The apparatus of claim 8, wherein the one or more configurations include a first configuration for PEI segment for the multiple non-adapted paging occasions and a second configuration for the one or more PEI segments for the one or more additional paging occasions.

10. The apparatus of claim 9, wherein the first configuration includes a first number of POs per PEI monitoring occasion for the multiple non-adapted paging occasions, and the second configuration includes a second number of POs per PEI monitoring occasion for the one or more additional paging occasions.

11. The apparatus of claim 9, wherein the first configuration includes a first payload size for a downlink control information (DCI) associated with the multiple non-adapted paging occasions, and the second configuration includes a second payload size for the DCI associated with the one or more additional paging occasions.

12. The apparatus of claim 9, wherein the first configuration includes a first PEI frame offset for the multiple non-adapted paging occasions, and the second configuration includes a second PEI frame offset for the one or more additional paging occasions.

13. The apparatus of claim 9, wherein the first configuration includes a first number of POs per PEI monitoring occasion, a first payload size for a downlink control information (DCI), and a first PEI frame offset for the multiple non-adapted paging occasions, and
wherein the second configuration includes a second number of POs per PEI monitoring occasion, a second payload size for the DCI, and a second PEI frame offset for the one or more additional paging occasions.

14. The apparatus of claim 8, wherein the one or more configurations include:
a single configuration for the PEI segment for the multiple non-adapted paging occasions and the one or more PEI segments for the one or more additional paging occasions,
the single configuration if the PEI segment for the multiple non-adapted paging occasions are jointly indicated in a single DCI with the one or more PEI segments for the one or more additional paging occasions, or
multiple configurations if the PEI segment for the multiple non-adapted paging occasions are jointly indicated in a separate DCI from the one or more PEI segments for the one or more additional paging occasions.

15. An apparatus for wireless communication at a network node, comprising:
at least one memory; and
at least one processor coupled to the at least one memory and, based at least in part on information stored in the at least one memory, the at least one processor is configured to:
transmit a paging early indication (PEI) segment for multiple non-adapted paging occasions prior to one or more PEI segments for one or more additional paging occasions that are scheduled to occur between the multiple non-adapted paging occasions; and
page at least one user equipment (UE) in at least one of the multiple non-adapted paging occasions or the one or more additional paging occasions based on a PEI indication.

16. The apparatus of claim 15, wherein the at least one processor is further configured to:
transmit one or more configurations for the PEI segment for the multiple non-adapted paging occasions and the one or more PEI segments for the one or more additional paging occasions.

17. The apparatus of claim 16, wherein the one or more configurations include a first configuration for PEI segment for the multiple non-adapted paging occasions and a second configuration for the one or more PEI segments for the one or more additional paging occasions.

18. The apparatus of claim 17, wherein the first configuration includes a first number of POs per PEI monitoring occasion, a first payload size for a downlink control information (DCI), and a first PEI frame offset for the multiple non-adapted paging occasions, and
wherein the second configuration includes a second number of POs per PEI monitoring occasion, a second payload size for the DCI, and a second PEI frame offset for the one or more additional paging occasions.

19. A method of wireless communication at a user equipment (UE), comprising:
receiving a paging early indication (PEI) segment for multiple non-adapted paging occasions prior to one or more PEI segments for one or more additional paging occasions that are scheduled to occur between the multiple non-adapted paging occasions; and
waking up to monitor at least one of the multiple non-adapted paging occasions or the one or more additional paging occasions based on a PEI indication.

20. The method of claim 19, further comprising:
receiving a first configuration for PEI segment for the multiple non-adapted paging occasions, wherein the first configuration includes a first number of POs per PEI monitoring occasion, a first payload size for a downlink control information (DCI), and a first PEI frame offset for the multiple non-adapted paging occasions, and
receiving a second configuration for the one or more PEI segments for the one or more additional paging occasions, wherein the second configuration includes a second number of POs per PEI monitoring occasion, a second payload size for the DCI, and a second PEI frame offset for the one or more additional paging occasions.
